(19) United States
(12) Patent Application Publication
(10) Pub. No.: US 2009/0111422 A1
(43) Pub. Date: Apr. 30, 2009

(54) Control Systems and Methods for a Personal Communication Device (PCD)

(76) Inventors: Gordon Bremer, Clearwater, FL (US); Patrick M. Murphy, Tampa, FL (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/262,657

(22) Filed: Oct. 31, 2008

Related U.S. Application Data
(60) Provisional application No. 60/984,017, filed on Oct. 31, 2007.

(51) Int. Cl. H04M 11/04; H04M 15/00; H04M 3/00

(52) U.S. Cl. 455/404.2; 455/406; 455/418

(57) ABSTRACT

Control systems and methods are provided for controlling a personal communication device (PCD), such as a wireless telephone, personal data assistant (PDA), etc. The control systems and methods enable the controlled PCD (CPCD): (1) to determine (a) CPCD motion (speed, acceleration, or both) and/or (b) geographical location and (2) to (a) modify (enable, disable, and/or otherwise change) one or more CPCD functions based at least in part on the CPCD motion and/or geographical location and/or (b) communicate an alert (locally and/or to a remote communication device). The control of CPCD functions and alerts may also be dependent on other factors, such as the laws of the authoritative legal jurisdiction wherein the CPCD is located. The operation of the following CPCD functions can be modified, as nonlimiting examples: keypad, image display, microphone, speaker, camera, voice call out, voice call answer, text message creation, text message transmission, text message reception, email creation, email reception, image creation, image reception, Internet browsing, gaming, ring signal operation, communication signal transmission, and communication signal reception.

### CROSS-REFERENCE TO RELATED APPLICATIONS

This document claims priority to and the benefit of the filing date of provisional application Ser. No. 60/984,017, filed Oct. 31, 2007, which is hereby incorporated by reference in its entirely.

### TECHNICAL FIELD

The present invention relates generally to tracking systems, telecommunications, and personal electronic systems, devices, and services.

### BACKGROUND OF THE INVENTION

The use of personal communication devices (PCDs), including wireless telephones, laptop computers, portable electronic devices and personal digital assistants (PDAs), in moving vehicles is a major public safety issue because a vehicle user may become distracted by one or more operations of the PCD. Some legal jurisdictions have passed laws restricting or prohibiting use of PCDs by a user during operation of a vehicle, but compliance to the law is poor, and public safety remains seriously compromised by continuing use of PCDs by users of vehicles.

PCD technologies and supporting wireless communication network technologies are well understood by those skilled in the art. An exemplary description of wireless telephones, the wireless communications network, and the risks to public safety are provided at http://en.wikipedia.org/wiki/Cell_phone and http:///en.wikipedia.org/wiki/Wireless_network, the disclosures of which are incorporated herein by reference in their entirety. An exemplary block diagram of a prior art wireless PCD 20 is illustrated in FIGS. 1A and 1B. An exemplary block diagram of prior art communication capabilities of PCD 20 is illustrated in FIG. 2. PCDs are provided, for example, by Nokia, Samsung, Motorola, LG, Apple, Blackberry, and others. Wireless services supporting PCDs are provided, for example, by Verizon, T-Mobile, AT&T, and others.

The geographical location of a device that incorporates GPS (Global Positioning System) technology is determined within the device by reception of GPS wireless signals and calculation of information derived there from. A summary description of GPS technology is provided at http://en.wikipedia.orq/wiki/Gps., which is incorporated herein by reference in its entirely. Some GPS devices also determine the speed of motion of the device from calculations of the change of geographical locations over a period of time. GPS devices routinely provide geographic location accuracy within 20 feet of actual, speed of motion accuracy within one mile per hour (mph) of actual and update location and speed of motion every several seconds. GPS devices furthermore store digital information that describes maps that enable accurate display of most streets and roads in, for example, the entire United States. GPS devices combine the calculated current geographical location with the stored digital map information and display the current location of the GPS device and the speed of motion on a monitor screen on the device. Examples of GPS devices are provided at www.magellangps.com and http://www.garmin.com/garmin/cms/site/us, the disclosures of which are incorporated herein by reference in their entirety.

PCDs increasingly incorporate both wireless telephone technology and GPS technology as illustrated in FIGS. 1A, 1B and FIG. 2. The current geographical location and the current speed of motion may be displayed on a map on the PCD 20 display. The PCD location can also be retrieved by the wireless service provider, for example, at a wireless call attempt. Other non-GPS means are also utilized by the wireless service provider to determine location, albeit with less accuracy. An example of a PDS with GPS is provided at http://www.apple.com/iphone/features/maps.html, which is incorporated herein by reference in its entirety.

Because of the public safety issues, a need exists for a personal communication device (PCD), such as a wireless telephone, that is capable of automatically and rapidly disabling PCD operations that may be distracting to the user of a vehicle when driving above a legally mandated speed of motion within a legal jurisdiction.

New technology fulfilling this need should have features that are desirable to legal authorities. The technology should provide for a plurality of and a hierarchy of jurisdictions including country, state, county or township, and municipality. The technology should preferably provide for the automatic modification, including disablement, of mandated PCD operations at all locations within the jurisdiction while also providing for override of such modification in selected areas within the jurisdiction where disablement is not necessary, for example, along a commuter train right-of-way. The technology should be capable of different modification and override parameters based on DOW and TOD.

While in possession by the user of a vehicle within a geographical modification area designated by a legal jurisdiction, those PCD operations selected by the legal authority should be automatically and quickly modified, for example, disabled, when the speed of motion of the PCD exceeds an established modification speed limit. Modification should persist for some time after movement stops to bridge short cessation of motion, such as a stop at a traffic light. Since some PCD operations, such as text message preparation and sending, can be performed without connection to the communication service, the modification control should be self-contained within the PCD and should not rely on actions, cooperation or control by of a wireless service provider. The legal authority may require that the PCD can be queried via the wireless service provider to ensure that the modification features of a PCD are present and operational. The legal authority may furthermore require that an enforcement officer can verify compliance via a PCD display mode. Preferably, the technology should be readily and easily downloadable, preferably automatically, into a PCD by either the user or the wireless service provider, so that potential objections of excessive difficulty or cost of installation can be overcome.

Such new technology should also be acceptable to and, preferably, desirable to a user of the PCD and to the supporting communication service. For example, normal PCD operation should be able to be automatically maintained when the user of the PCD is not within the legal jurisdiction. Normal PCD operation should be automatically maintained when in the legal jurisdiction and while exceeding the established disablement speed limit but not operating a vehicle, for example while a passenger in a car or while riding public transportation such as a train or bus. Normal PCD operation should be automatically maintained under conditions requiring emergency communication, such as “911”. Normal PCD operation should be maintained for PCD hands-free operations, if permitted by laws.

Irrespective of any legal requirements and independent of the communication service provider, the technology should provide for the PCD user to voluntarily set operation modification parameters into the PCD, perhaps under personal identification number (PIN) security control, for self-protection, parental control, automobile insurance requirements or control by an employer owning the PCD. These voluntary modification parameters may include speed of motion limits, operations to be disabled, operations to be enabled and geographical locations for modification.

The technology should provide for use of other aspects of motion, such as acceleration and deceleration, to modify PCD operations. The technology should provide for use of all aspects of motion to automatically send alerts and messages.

### SUMMARY OF THE INVENTION

The present invention provides control systems and methods for controlling a personal communication device (PCD), such as a wireless telephone, personal data assistant (PDA), etc. The control systems and methods enable the controlled PCD (CPCD): (1) to determine (a) CPCD motion (speed, acceleration, or both) and/or (b) geographical location and (2) to (a) modify (enable, disable, and/or otherwise change the operation of) one or more CPCD functions based at least in part upon the CPCD motion and/or geographical location and/or (b) communicate an alert (locally and/or to a remote communication device). The control of CPCD functions or alerts may also be dependent on other factors, such as the laws of the authoritative legal jurisdiction wherein the CPCD is located and time information, such as the day of the week and the time of day. The operation of the following CPCD functions can be modified, as nonlimiting examples: keypad, image display, microphone, speaker, camera, voice call out, voice call answer, text message creation, text message transmission, text message reception, email creation, email reception, image creation, image reception, Internet browsing, gaming, ring signal operation, communication signal transmission, and communication signal reception.

Some embodiments of the present invention include a provision to selectively override control, for example, to permit normal CPCD operation for mobile vehicle passengers (as opposed to a driver), for riders on public transportation, for hands-free operation by a driver, or for “911” emergency use. Modification can be automatically accomplished solely by the CPCD itself or with the cooperation of a CPCD communication service provider. Thus, public and personal safety is improved by permitting automatic disablement of potentially dangerous CPCD use by a user of a vehicle that is moving above a vehicle speed established, for example, in the authoritative legal jurisdiction.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1A is a block diagram illustrating the architecture of a prior art personal communication device (PCD).

FIG. 1B is a block diagram illustrating the functionality of the prior art PCD of FIG. 1A.

FIG. 2 is a block diagram illustrating communication capabilities of the prior art PCD of FIG. 1B.

FIG. 3A is a block diagram illustrating the architecture of a controlled PCD (CPCD) wherein the control system of the present invention can be implemented.

FIG. 3B is a block diagram illustrating the functionality of the CPCD of FIG. 3A.

FIG. 4 is an exemplary flow diagram of the first preferred embodiment of the control system of FIG. 3B.

FIG. 5 is a diagram illustrating exemplary geographical legal jurisdictions.

FIG. 6 is a diagram illustrating exemplary geographical modification areas.

FIG. 7 is a diagram illustrating exemplary geographical override areas.

FIG. 8A is a diagram illustrating a modification area.

FIG. 8B is a diagram illustrating an override area.

FIG. 9 is an exemplary flow diagram of the second preferred embodiment of the control system of the CPCD of FIGS. 3A, 3B.

FIG. 10 is an exemplary flow diagram of the third preferred embodiment of the control system of the CPCD of FIGS. 3A, 3B.

FIG. 11 is a block diagram illustrating an exemplary alternative architecture of the CPCD of FIGS. 3A, 3B wherein the third preferred embodiment of the control system of FIG. 10 can be implemented.

FIG. 12A is a flow diagram of the fourth preferred embodiment of the control system of FIGS. 3A, 3B.

FIG. 12B is a flow diagram of the fifth preferred embodiment of the control system of FIGS. 3A, 3B.

FIG. 13 is a diagram illustrating a designated roadway.

FIG. 14 is a flow diagram of the sixth preferred embodiment of the control system of FIGS. 3A, 3B.

FIG. 15 is a flow diagram of the seventh preferred embodiment of the control system of FIGS. 3A, 3B.

FIG. 16 is a flow diagram of the eighth preferred embodiment of the control system of FIGS. 3A, 3B.

FIG. 17A is a flow diagram of the ninth preferred embodiment of the control system of FIGS. 3A, 3B.

FIG. 17B is a flow diagram of an alternative ninth preferred embodiment of the control system of FIGS. 3A, 3B.

FIG. 18A is a flow diagram of a tenth preferred embodiment of the control system of FIGS. 3A, 3B.

FIG. 18B is a flow diagram of an alternative tenth preferred embodiment of the control system of FIGS. 3A, 3B.

FIG. 19 is a block diagram illustrating another exemplary alternative architecture of the CPCD of FIGS. 3A, 3B wherein motion and location information are determined remotely by a vehicle control system and are communicated to the CPCD of FIGS. 3A, 3B.

FIG. 20 is a block diagram illustrating an embodiment wherein the CPCD of FIGS. 3A, 3B is interfaced via a Bluetooth to a vehicle control system of a motor vehicle.

FIG. 21 is a flow diagram of an eleventh preferred embodiment of the control system of FIGS. 3A, 3B that is implemented in the CPCD of FIG. 20.

FIG. 22 is a block diagram illustrating ways to install the control system into a PCD in order to implement the CPCD of FIGS. 3A, 3B.

### DETAILED DESCRIPTION OF THE INVENTION

### A. Architecture/Functionality of Prior Art Personal Communication Device (PCD)

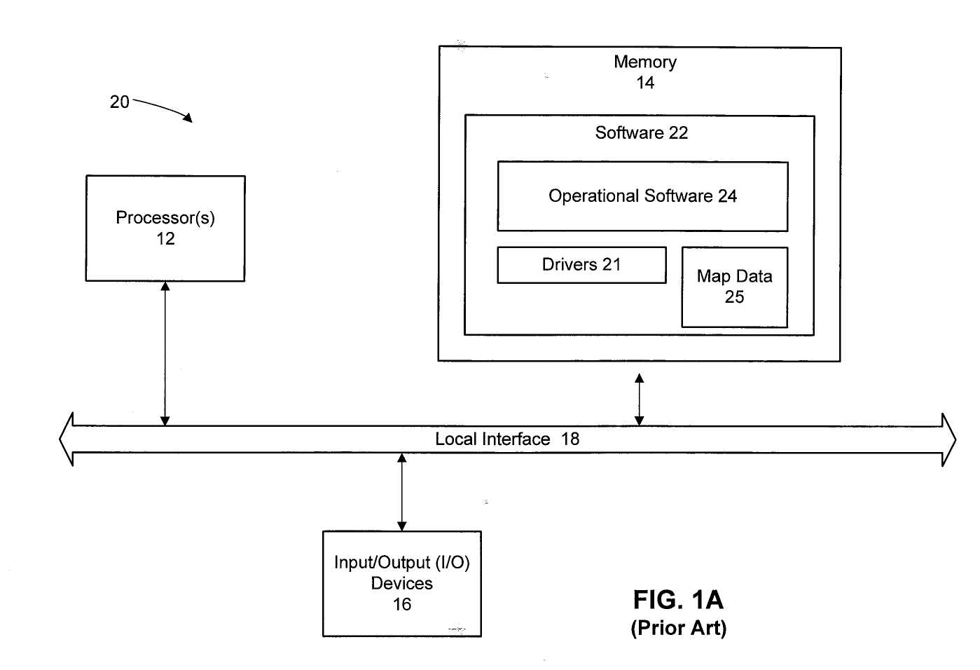

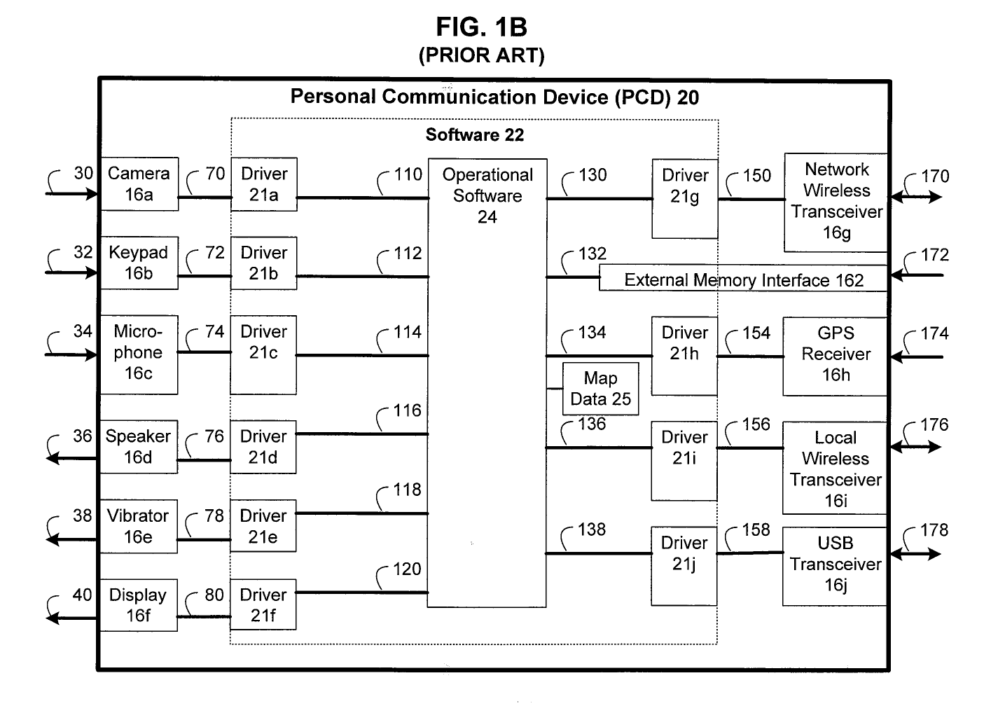

FIGS. 1A and 1B show an example of an existing architecture and functionality of a typical personal communication device (PCD) 20 of the prior art. This example of a PCD 20 in FIGS. 1A and 1B has a computer-based architecture with one or more processors 12 for executing software (program) instructions from, among other things, on-board software associated with drivers 21 and operational software 24. The foregoing software is stored in one or more computer readable media, denoted as memory 14 (ROM, RAM, etc.) situated in the PCD 20.

1. Existing PCD User Interfaces Functionality

With reference to FIG. 1B, the existing PCD functionality of PCD 20 includes user interfaces 30, 32, 34, 36, 38 and 40 (or input/output devices) which permit a user to input information to the PCD 20 and to receive information from the PCD 20.

A keypad 16b provides for input of information via depressing or touching PCD 20 mechanical keys. An example of such information is a calling number sequence. Keypad 16b is coupled via communication path 72 to software keypad driver 21b, a computer software program that interprets a keypad key stroke or a succession of key strokes and provides such information to other computer programs located in the operational software 24 via communication path 112.

A microphone 16c provides for reception of analog acoustic information and includes conversion of the received analog audio signal into a sampled digital representation of the audio signal suitable for use by computer software. The microphone 16c is coupled via communication path 74 to software microphone driver 21c, a computer program that provides the sampled digital representation of the received audio signal to other computer programs located in the operational software 24 via communication path 114.

A speaker 16d provides for the transmission of analog audio acoustic information and includes conversion of sampled digital information that represents the audio to be transmitted. Speaker 16d is coupled via communication path 76 to software speaker driver 21d, a computer program that receives a sampled digital representation of the audio signal to be transmitted from other computer programs located in the operational software 24 via communication path 116 and provides this to the speaker 16d.

A vibrator 16e provides for the output of sensory mechanical information from the PCD 20. The vibrator 16e is coupled via communication path 78 to software vibrator driver 21e, a computer program that receives a digital representation of the intended state of the vibrator 16e from other computer programs located in the operational software 24 via communication path 118 and accordingly turns the vibrator 16e on and off.

A display 16f provides an image display of two-dimensional visual information and includes conversion of sampled digital information that represents the image. display 16f is coupled via communication path 80 to software display driver 21f, a computer program that receives a sampled digital representation of the image signal to be displayed from other computer programs located in the operational software 24 via communication path 120 and provides this to the display 16f.

A camera 16a provides for reception of analog visual information and includes conversion of the received visual signal into a sampled digital representation of the visual signal. Camera 16a is coupled via communication path 70 to software camera driver 21a, a computer program that provides the sampled digital representation of the visual signal to other computer programs located in the operational software 24 via communication path 110.

2. Existing PCD Communication Interfaces Functionality

Continuing with reference to FIG. 1B, the PCD 20 embodies communication interfaces 170, 172, 174, 176, and 178 which permit the PCD 20 to transmit information to external services or external devices and/or to receive information from external services or external devices.

A network wireless transceiver 16g provides bi-directional wireless voice, text, image, data, video and other communications with a compatible device, wireless network or other wireless network. The network wireless transceiver 16g receives wireless radio signals and converts the information contained therein into digital information suitable for communication to a PCD 20 computer program located in the operational software 24 via communication paths 130 and 150. The network wireless transceiver 16g converts digital information received from a PCD 20 computer program located in the operational software 24 via communication paths 150 and 130 into a wireless radio signal and transmits the radio signal. The network wireless transceiver 16g is coupled via communication path 150 to software wireless driver 21g, a computer program that interfaces with and controls the network wireless transceiver 16g.

A local wireless transceiver 16i provides bi-directional wireless communication with a local compatible wireless device. The local wireless transceiver 16i receives wireless signals from an external wireless device and converts the information contained therein into digital information suitable for communication to a PCD 20 computer program located in the operational software 24 via communication paths 156 and 136. The local wireless transceiver 16i converts digital information received from a PCD 20 computer program located in the operational software 24 via communication paths 156 and 136 into a wireless signal and transmits the wireless signal. Non-limiting examples of wireless communications include Bluetooth and IEEE 802.11 (Wi-Fi). The local wireless transceiver 16i is coupled via communication path 156 to software wireless driver 21i, a computer program that interfaces with and controls the local wireless transceiver 16i.

A universal serial bus (USB) transceiver 16j provides bi-directional wired communication with an external compatible USB device over a USB connection. The USB transceiver 16j receives USB signals from an external compatible USB device and converts the information contained therein into digital information suitable for communication to a computer program of PCD 20 located in the operational software 24 via communication paths 138 and 158. The USB transceiver 16j converts digital information received from a PCD 20 computer program located in the operational software 24 via communication path 138 into a USB signal and transmits the USB signal. The USB transceiver 16j is coupled via communication path 158 to software USB driver 21j, a computer program that interfaces with and controls the USB transceiver 16j.

A global positioning system (GPS) receiver 16h receives information suitable for calculating geographical location and time signals from GPS Satellites 204. The GPS receiver 16h is coupled via communication path 154 to the software GPS driver 21h which conveys the received information to a computer program located in the operational software 24 via communication path 134. In many implementations, the GPS receiver 16h determines the receiver's location values relative to the Earth's zero degree latitude and zero degree longitude reference point, which is located at the intersection of the Equator and the Prime Meridian. U.S. Pat. No. 5,781,156 entitled, “GPS Receiver and Method for Processing GPS Signals” and filed on Apr. 23, 1997 by Krasner, which is incorporated herein by reference, discusses a receiver for the processing of GPS signals 21 received from GPS satellites in order to determine the receiver's location values.

An external memory interface 162 accepts coupling of a computer memory card, such as an secure digital (SD) card. Upon installation of a memory card, the operational software 20 has read/write access to the computer memory of the card, including any information contained on the memory card prior to installation into the PCD, via communication path 132.

3. Existing PCD Functions

Continuing with reference to FIG. 1B, an outgoing wireless voice call may be initiated from the user interfaces 30, 34 of PCD 20. The called party telephone number is first entered into the PCD 20 or retrieved from a PCD 20 memory displayed by the display 16f by use of keypad 16b. The called party telephone number is first stored within the PCD 20 controlled, for example, by operational software 24. Additional keystrokes are then entered to initiate the call, and upon receipt of said keystroke information, the operational software 20 begins a communication attempt to the wireless network including conveying the stored called party telephone number via the network wireless transceiver 16g. Upon receipt by the PCD 20 of an answer acknowledgement from the called party via the wireless network, outgoing voice transmission is enabled over the wireless network which includes the use of the microphone 16c, microphone driver 21c and operational software 24. Incoming voice communication from the called party is also enabled which includes the use of the operational software 24, speaker driver 21d and speaker 16d. The incoming call may be terminated at the PCD 20 by a keypad 16b “End Call” or equivalent keystroke activation. For an outgoing call to be so initiated, normal keypad 16b operation is required. Since an outgoing call is required to retrieve a voice message, normal keypad operation is required to retrieve a voice message. For a call to be maintained, normal microphone 16c operation and normal speaker 16d operations are required. An outgoing call is terminated at the PCD 20 by a keypad 16b “End Call” or equivalent keystroke activation. If the PCD 20 is being monitored and controlled by an external device, such as Personal Computer 200 connected to the PCD 20, for example, via the local wireless transceiver 16i or the USB transceiver 16j, the equivalent PC operations of keypad entry should operate normally.

Outgoing text message creation and sending is normally initiated from the User Interfaces 32, 34 of PCD 20. The called party telephone number is first entered into the PCD 20 or retrieved from a PCD 20 memory displayed by the display 16f by use of keypad 16b. The called party telephone number is first stored within the PCD 20 by operational software 24. Additional keystrokes are then entered to draft the text message. More keystrokes are then entered to send the message, and upon receipt of said keystrokes within the PCD 20, the operational software 24 begins a communication attempt including conveying the stored called party telephone number and the text message via the network wireless transceiver 16g to the Wireless Network 202. For an outgoing text message to be created and sent, normal keypad operation is required. If the PCD 20 is being monitored and controlled by an external device, such as a personal computer (PC) 200, connected to the PCD 20, for example, via the local wireless transceiver 16i or the USB transceiver 16j, then the equivalent PC operations of keypad entry should operate/normally.

The PCD 20 normally notifies the user of an incoming wireless voice call or a pending voice message or a pending text message or an internal PCD 20 event, such as an alarm, by the sounding of a ringing tone or an alert tone via operational software 24, speaker driver 21d, and speaker 16d. The PCD 20 may notify the user of an incoming wireless voice call or a pending voice message or a pending text message or an internal PCD 20 event such as an alarm by turning on the vibrator 16e via operational software 24, vibrator driver 21e and vibrator 16e. The PCD 20 may notify the user of an incoming wireless voice call or a pending voice message or a pending text message or an internal PCD 20 event such as an alarm by displaying one or more images on the display 16f. A user is normally unaware of and unable to answer an incoming voice call or a pending voice message or an incoming text message or an internal PCD 20 event such as an alarm if the speaker 16d is off and the vibrator 16e is off and the display 16f is dark. An incoming call is terminated at the PCD 20 by a keypad “end call” or equivalent keystroke activation. If the PCD 20 is being monitored and controlled by an external device, such as a personal computer connected to the PCD 20, for example, via the local wireless transceiver 16i or the USB transceiver 16j, then the equivalent PC operations of speaker, display, and keypad operation should operate normally.

A capture of a camera image or photo is normally initiated by keypad strokes using the keypad 16b, thereby enabling camera 16a, camera driver 21a and the operational software 24. The PCD 20 cannot be used to take a camera photo image if the camera 16a is off or the camera driver 21a is off or if the keypad 16b keys used to activate the camera 16a are disabled.

4. Existing Global Positioning System (GPS) Functionality

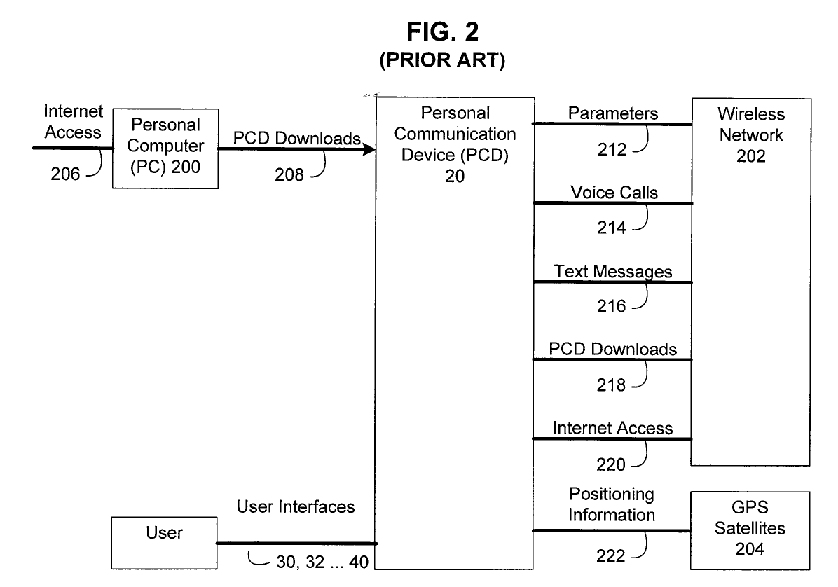

Continuing with reference to FIG. 1B and FIG. 2, the GPS receiver 16h, the GPS driver 21h, and the operational software 24 together determine the geographical location and speed of motion (SOM) of the PCD 20 by reception of GPS wireless signals from GPS Satellites 204 and calculation of information derived therefrom, as is well known in the art. Geographical latitude and longitude location or other data indicative of location is calculated and made available for use by other computer programs within operational software 24, for example, in terms of geographical degrees, minutes and seconds with seconds expressed to the nearest one-hundredth of a second. SOM is the change of geographical location per unit time of a PCD 20. SOM can be calculated and presented, for example, in terms of miles per hour (mph). Exemplary geographic location accuracy is within 20 feet of actual and SOM accuracy is within one mph of actual. The GPS location and SOM are calculated periodically.

5. Existing Map Data Functionality

The PCD 20 may also be equipped with geographical map data 25 (digital information that describes maps), which can include roadway and other information. The map data 25 can be stored and updated in memory and shown to the user on display 16f.

Furthermore, the map data 25 can be correlated with the GPS data received from GPS receiver 16h so that the PCD position can be shown to the user on a map via display 16f. More specifically, the PCD 20 can combine the calculated current geographical location with the stored digital map information and can display the current location of the PCD 20 on the display 16f. The SOM of the PCD 20 device can also displayed. The PCD 20 location can also be retrieved by the wireless service provider at a call establishment event.

### B. Controlled PCD (CPCD)

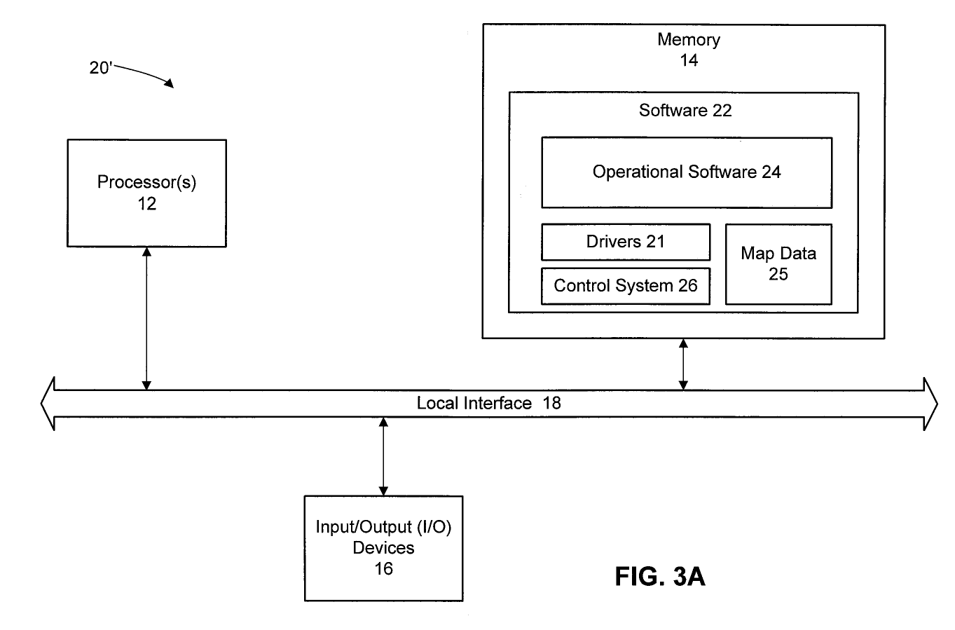

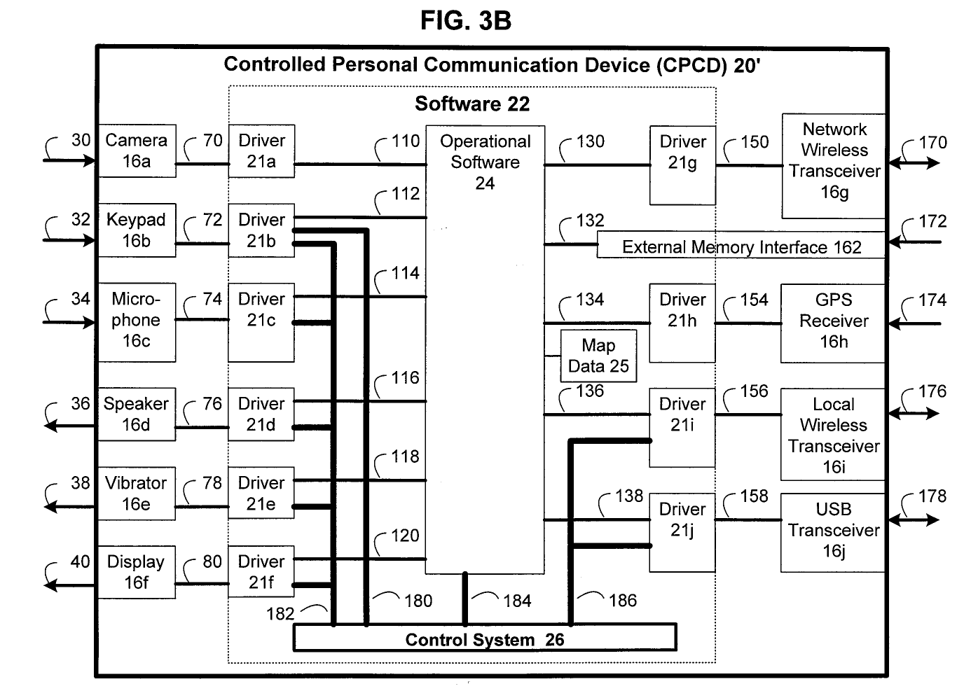

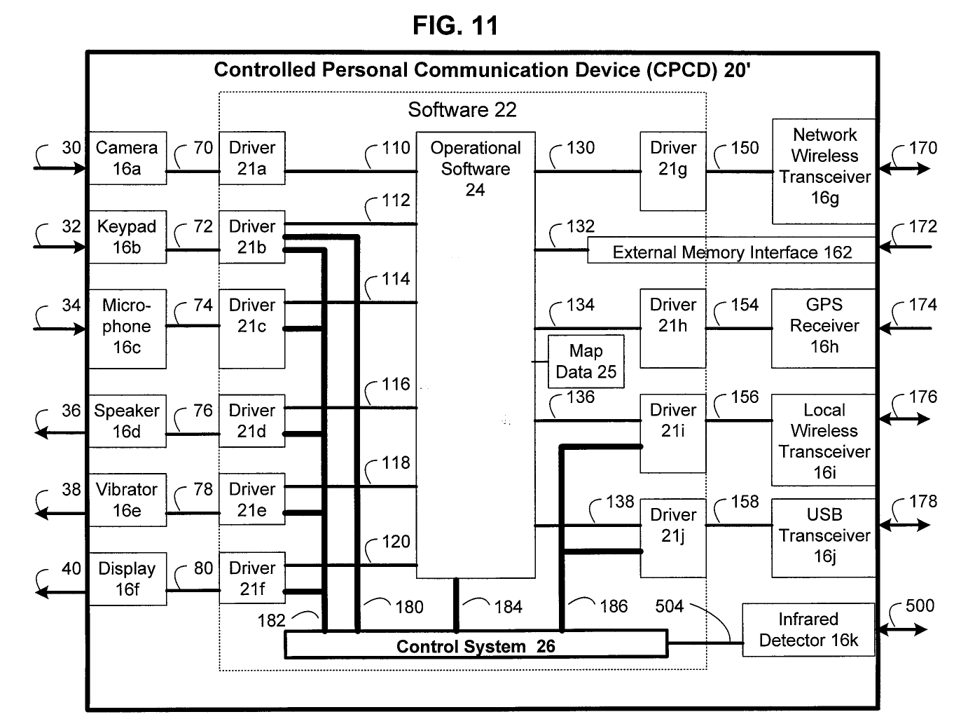

The present invention provides control systems and methods for controlling a PCD 20. The control systems and methods enable the controlled PCD (CPCD), the architecture of which is denoted by reference numeral 20′ in FIGS. 3A, 3B (and an alternative embodiment in FIG. 11), to sense CPCD motion and/or geographical location and to (a) modify, including enabling, disabling, and/or otherwise changing, one or more CPCD functions based at least in part on the CPCD motion and/or geographical location and/or (b) communicate an alert (locally or to a remote communication device). In the context of this document, the CPCD is any portable or transportable device that (a) can be used by the user for communication, for information entry, and/or for information presentation and (b) can determine or obtain CPCD location and/or motion information pertaining to the CPCD. Non-limiting examples of CPCDs are as follows: a wireless telephone (e.g., cellular telephone, 802.11 based telephone, etc.), a personal data assistant (PDA), a portable audio device, a portable video device, a portable audio/video device (e.g., an ipod), etc. Wireless encompasses any and all wireless communication services, including but not limited to, those for conveying voice, text, data, images, and/or video. Furthermore, the one or more CPCD functions that can be controlled include, but are not limited to, the following: keypad, image display, microphone, speaker, camera, voice call out, voice call answer, message creation, message transmission, message reception, email creation, email reception, image creation, image reception, Internet browsing, gaming, ring signal operation, communication signal transmission, and communication signal reception.

1. CPCD That Can Disable Detrimental CPCD Functions

Table 1 set forth hereafter lists CPCD functions that can be considered potentially detrimental to the safe operation of a mobile vehicle (any air, land, or sea vessel capable of movement and capable of being in interaction with a user, for example but not limited to, a motor vehicle, train, water vessel, airplane, helicopter, bicycle, etc.). In preferred embodiments, the CPCD 20′ disables use of one or more of these potentially detrimental CPCD functions . The following functionality instructions in CPCD 20′ would disable all Table 1 CPCD functions that are potentially detrimental to the safe operation of a mobile vehicle:
1. Disable use of all keys of keypad 16b.
2. Disable use of speaker 16d.
3. Disable (preferably, darken) display 16f.
4. Disable use of vibrator 16e.
5. Disable use of microphone 16c.
6. Disable use of local wireless transceiver 16i and use of USB transceiver 16j.
   It is unnecessary and inadvisable to disable or alter normal communication between the CPCD 20′ and the wireless network 202. The above changes in the functionality of the CPCD 20′ appear as normal CPCD functions to the wireless network 202, so changes to the wireless network 202 are not mandatory, and the wireless network 202 is not disrupted by any of these functional changes.

TABLE 1

| | | | | | | Wireless |
|---|---|---|---|---|---|---|
| | | | | | | and USB |
| Detrimental | Keypad | Speaker | Display | vibrator | Microphone | Transceivers |
| Function | Change | Change | Change | Change | Change | Change |
| Place | Disable | — | — | — | Disable | Disable |
| outgoing | all keys | | | | (Note 2) | reception |
| voice call | (Note 1) | | | | | (Note 3) |
| Continue | Activate | — | — | — | — | — |
| voice call | “End | | | | | |
| | Call” key | | | | | |
| | (Note 4) | | | | | |
| Notification | — | Disable | Darken | Disable | | Disable |
| of incoming | | | | | | transmission |
| call | | | | | | (Note 5) |
| Create or | Disable | — | — | — | — | Disable |
| send text | all keys | | | | | reception |
| message | | | | | | (Note 3) |
| Notification | — | Disable | Darken | Disable | | Disable |
| of any | | | | | | transmission |
| incoming | | | | | | |
| message | | | | | | |
| Connect to | Disable | — | — | — | — | Disable |
| and use | all keys | | | | | reception |
| Internet | | | | | | (Note 3) |
| Retrieve | Disable | — | — | — | Disable | Disable |
| voice | all keys | | | | (Note 2) | reception |
| message | | | | | | (Note 3) |
| Use of | Disable | — | Darken | — | — | — |
| camera | all keys | | | | | |
| Access | Disable | | Darken | | | |
| CPCD via | all keys | | | | | |
| keypad | | | | | | |
| View | — | — | Darken | — | — | — |
| Display | | | | | | |

(Note 1): allow operation for emergency numbers such as 911.
(Note 2): disables use of speech recognition call establishment.
(Note 3): disables control from a connected device.
(Note 4): compatible with wireless service. Properly terminates call.
(Note 5): disables alert by a connected device.

2. Architecture of CPCD

FIGS. 3A and 3B are block diagrams illustrating the architecture and functionality of a CPCD 20′.

Generally, the CPCD 20′ is designed as and has similar architecture and functionality as PCD 20, but further includes a control system 26, which can be implemented in hardware, software, or a combination thereof. In the preferred embodiments of the present invention, the control system 26 is implemented in software. Just as software 22 and operational software 24, the control system 26 is stored on one or more computer readable media, denoted as memory 14 in FIG. 3A, associated with the CPCD 20′ and is executed by one or more processors 12 associated with the CPCD 20′. Furthermore, the control system 26 may be stored on a computer readable medium that is unassociated with the CPCD 20′ for storage, transfer, distribution, etc.

A “computer-readable medium” can be any apparatus that can contain, store, communicate, propagate, or transport the program for use by or in connection with one or more processors. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium include the following: an electrical connection (electronic) having one or more wires, a portable computer diskette (magnetic), a random access memory (RAM), a read-only memory (ROM), an erasable programmable read-only memory (EPROM or flash memory) (magnetic or electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Generally, in terms of hardware architecture, as shown in FIG. 3A, the CPCD 20′ includes one or more processors 12, memory 14 containing the control system 26, and one or more I/O devices 16 that are communicatively coupled via a local interface 18. The local interface 18 can be, for example but not limited to, one or more buses or other wired or wireless connections, as is known in the art. The local interface 18 may have additional elements, which are omitted for simplicity, such as controllers, buffers (caches), drivers, repeaters, and receivers, to enable communications. Further, the local interface may include address, control, and/or data connections to enable appropriate communications among the aforementioned components. The processor(s) 12 is a hardware device for executing software, particularly that stored in memory 14. The processor(s) 12 can be any custom made or commercially available processor.

Control system 26 can selectively modify the functionality of keypad driver 21b, microphone driver 21c, speaker driver 21d, vibrator driver 21e, display driver 21f, wireless driver 21i, and USB driver 21j. Control system 26 is designed to monitor “911” ECAs on keypad 16b and can cause the keypad driver 21b to emulate keypad operation of the “end call” key. Control system 26 is designed to read certain operational software 24 parameters, including the GPS SOM and GPS geographical location.

Control system 26 is designed to set or determine the state of a parameter for each CPCD function that can be disabled. In the preferred embodiments, the parameter for each CPCD function is binary. The state of each binary parameter (i.e., either disable or enable) either allows the affected CPCD function to be disabled (ON state) under certain conditions or forces normal operation (OFF state). For a first preferred embodiment and a third preferred embodiment described below, the state of each binary parameter is fixed in the control system 26 (not a function of location). For a second preferred embodiment described below, the state of each binary parameter is variable as determined by the control system 26 based on the immediate geographical location of CPCD 20′.

The following CPCD functions can be modified as follows:

| CPCD Function | Parameter | Modify (Enable/Disable) |
|---|---|---|
| Keypad 16b | KPDI | Keypad entries other than “911” are |
| | | not conveyed to operational |
| | | software 24. |
| Speaker 16d | SPKI | Speaker is silenced. |
| Display 16f | DSPI | Display is turned off. |
| Vibrator 16e | VBRI | Vibrator is turned off. |
| Microphone 16c | MICI | Microphone is muted. |
| Wireless Transceiver | WLTI | Wireless transceiver is disabled. |
| 16i | | |
| USB Transceiver 16j | USBI | USB transceiver is disabled. |

In the preferred embodiments described below, only parameter KPDI is set to the disable state: KPDI(ON). That is, only keypad operation can be disabled in these examples. However, the same description is applicable to each parameter that is set to the ON state, and the control system 26 performs the described operations for each such parameter.

### B. First Preferred Embodiment—CPCD Function Modification Based On Speed Of Motion (SOM)

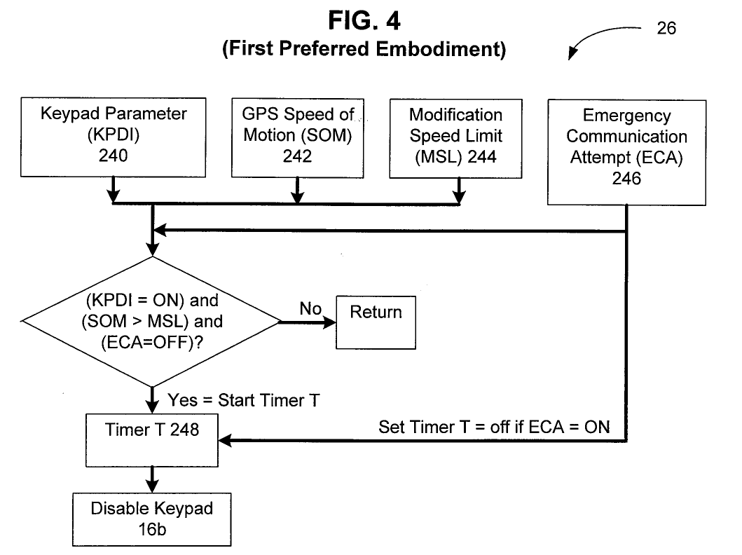

FIG. 4 is an exemplary flow diagram illustrating the first preferred embodiment of the control system 26. In this first preferred embodiment, the CPCD 20′ includes both wireless telephone communication technology and GPS technology with SOM determination. A modification speed limit (MSL), for example, 10 miles per hour, and one or more CPCD functions to be modified at an SOM above the MSL, for example, keypad 16b operation, are entered into and stored in the CPCD 20′ software 22. Modification information can be predefined in the control software 26, and, in some embodiments, can be predefined and/or changed by the user via a suitable user interface. The MSL is essentially an SOM limit above which one or more CPCD functions may be modified. Modification of a function generally includes disabling, enabling or otherwise changing the operation of the function.

Within the CPCD 20′, parameter SOM is compared to parameter MSL after a GPS location determination update, for example, every several seconds. Concurrently and continuously, ECA's are monitored, for example, a “911” key pad entry. If parameter SOM exceeds parameter MSL and no ECA is present, then the selected CPCD functions are modified. At any time that an ECA is present or if an emergency call is in progress or at any time that parameter SOM does not exceed MSL for a time period, the CPCD functions are returned to normal operation.

Referring to FIG. 4, any call attempts on keypad 16b are continuously monitored by control system 26. Upon sensing an attempt to call “911”, the parameter ECA 246, which is normally OFF, is set to ON. ECA remains ON until CPCD keystroke “end call” is detected or the “911” is otherwise terminated.

The control system 26 contains a parameter KPDI 240, contains a parameter MSL 244, and reads a parameter GPS SOM 242 from the operational software 24 (FIGS. 3A, 3B). If (KPDI 240=ON) and (SOM 242>MSL 244) and (ECA 246=OFF), then timer T 248 is started and set to ON. The operation of keypad 16b is disabled when timer T 248 is ON. The duration of timer T 248 is selected to bridge time periods when the SOM 242 does not exceed MSL 244 for short periods of time. An exemplary value of time T is 15 seconds. At any time that ECA 246=ON, timer T 248 is set to OFF.

The first preferred embodiment improves public and personal safety by rapidly disabling distracting and detrimental CPCD functions when the CPCD 20′ motion exceeds an established speed limit without regard to geographical location of the CPCD 20′ and without the need for communication with or cooperation of the wireless network.

### D. Second Preferred Embodiment—CPCD Function Modification Supplemented With Use Of Geographical Location

In a second preferred embodiment, the first preferred embodiment (FIG. 4) is augmented with a jurisdiction enable map (JEM) and a jurisdiction override map (JOM). The JEM describes geographical modification areas (MAs) within the jurisdiction which define which CPCD functions are to be modified and conditions for such modification. The JOM describes geographical override areas (OAs) within the jurisdiction which define which modification instructions are to be overridden and conditions for such override. Override refers to providing normal operation of an otherwise modified function. An OA has priority over an MA. Both the JEM and the JOM are downloadable from the wireless service provider or other sources. The JEM and the JOM may contain information of a plurality of jurisdictions. When the CPCD 20′ location is changed from one jurisdiction to another, the JEM and the JOM can be updated by downloading, if necessary.

The JEM and the JOM each comprise, for example, digital information loaded into and stored in a CPCD 20′ memory. Concurrently and continuously, the CPCD 20′ GPS location is compared to the JEM and the JOM. A CPCD function is modified if the CPCD 20′ location is within an MA and not within an OA that overrides the modification instruction.

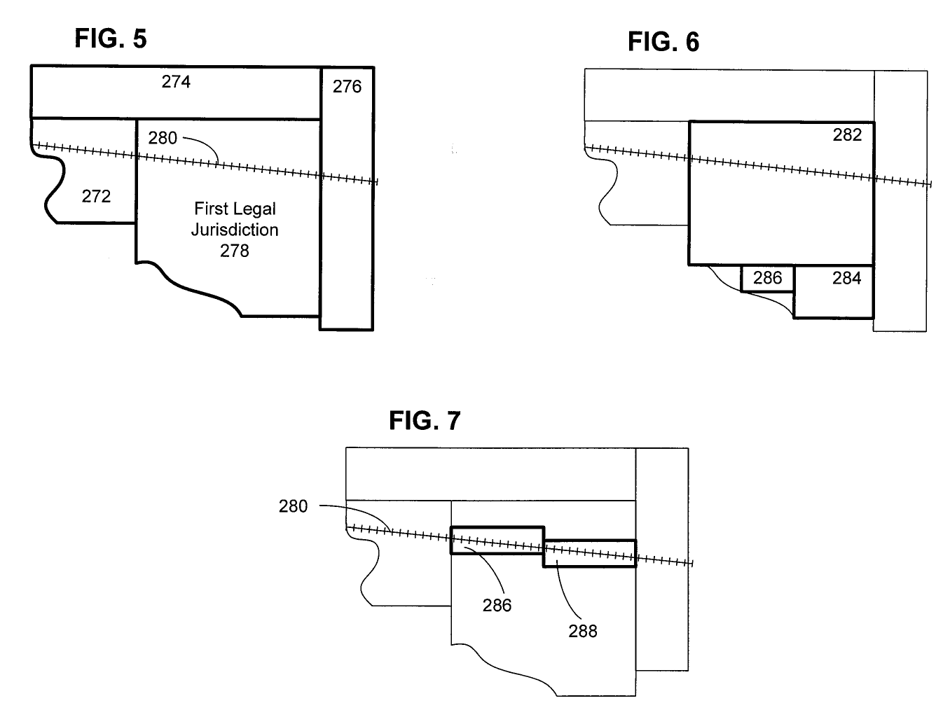

An example will now be described with reference to the illustrations in FIGS. 5 through 8B. MAs are shown as rectangular geographical areas. The set of all MAs intended to affect the operation of CPCD 20′ constitutes a JEM. Other rectangular geographical areas, i.e., OAs, are identified in which normal operation of one or more CPCD functions otherwise disabled within an MA are restored under conditions established for the OA. The set of all OAs intended to affect the operation of CPCD 20′ constitutes a JOM. The augmentation is implemented in control system 26.

With reference to FIG. 5, first legal jurisdiction 278 intends to disable selected operations of CPCD 20′ in its jurisdiction when a SOM 242 exceeds 10 mph. Adjacent legal jurisdictions 272, 274 and 276 have different disablement requirements than first legal jurisdiction 278, so first legal jurisdiction 278 identifies and describes MAs that are exclusively within its jurisdiction. First legal jurisdiction 278 chooses to identify and describe MAs numbered 282, 284, and 286 as illustrated in FIG. 6. These cover an acceptable majority of the geographical area of first legal jurisdiction 278. First legal jurisdiction 278 can later define other MAs to more fully cover its jurisdiction, if it so chooses. Adjacent legal jurisdictions 272, 274 and 276 and perhaps other jurisdictions not illustrated in FIG. 5 may identify their own individual MAs. The set of all MAs in a geographical region intended to affect the operation of CPCD 20′ constitute a JEM. The JEM is downloaded into CPCDs 20′ located in first legal jurisdiction 278 in a manner described elsewhere herein.

Furthermore, the first legal jurisdiction 278 intends to exclude from function modification those CPCDs 20′ located on commuter trains on railroad 280. First legal jurisdiction 278 chooses to identify and define OAs 286 and 288 as illustrated in FIG. 7. The set of OAs in a geographical region intended to affect the operation of CPCD 20′ constitute a JOM. The JOM is downloaded into CPCDs located in legal jurisdiction 278 in a manner described elsewhere herein.

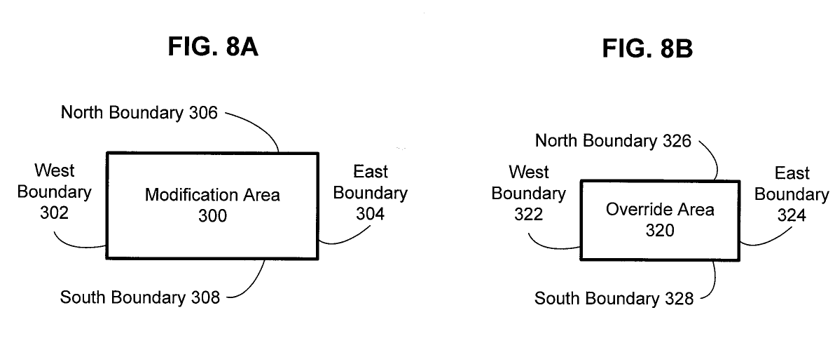

The geographical description of each MA, a jurisdiction code, a local MA number, and conditions for CPCD function modification within each MA are described by a 64 digit MA information frame shown in Table 2A, set forth hereafter. A set of MA information frames describes a JEM 340. The JEM 340 thus describes a set of geographical areas where CPCD function modification may occur and under what conditions. The MA information frame provides for identification of 10 trillion MAs. In this exemplary embodiment, far fewer MA information frames are actually utilized. For example, to cover the generally rectangular U.S. State of Colorado with one set of state-wide disablement rules may require only one MA information frame. The jurisdiction code is provided so that the jurisdiction that established the MA can be identified. Each MA is geographically rectangular with the sides running north-south and east-west as illustrated in FIG. 8A. Note that other shapes for the MAs and OAs are possible. The MA information frame provides for the geographical description of each MA by identifying each of the east, west, north and south MA boundaries to a latitudinal and longitudinal accuracy of one-one-hundredths of a geographical second (about one foot). The exemplary latitudinal and longitudinal format is degrees, minutes, and seconds accurate to two decimal places. Within each MA information frame an MSL 360 is identified, one of 100 possible combinations of CPCD functions that can be disabled is identified, and the ability to respond to an external override signal (EOS) 406 is identified.

The geographical description of each OA, a jurisdiction code, a local OA number, and conditions for CPCD function modification override within each OA are described by a 64 digit OA information frame shown in Table 2B, set forth hereafter. A set of OA information frames describes a JOM 344. The JOM 344 thus describes a set of geographical areas where CPCD function modification override may occur and under what conditions. The OA information frame format provides for identification of 10 trillion OAs. In this exemplary embodiment, far fewer OAs are actually utilized. For example, to address desired public transportation routes in the U.S. State of Colorado where normal CPCD function is desirable may require only several hundred OAs. To address desired public transportation routes in Pinellas County, Florida, no OAs may be required. The jurisdiction code is provided so that the jurisdiction that established the OA can be identified. Each OA is geographically rectangular with the sides running north-south and east-west as illustrated in FIG. 8B. The OA information frame provides for the geographical description of each OA by identifying each of the east, west, north and south OA boundaries to a latitudinal and longitudinal accuracy of one-one-hundredths of a geographical second (about one foot). The exemplary latitudinal and longitudinal format is degrees, minutes, seconds accurate to two decimal places. Within each OA information frame, one of 100 possible combinations of CPCD function modification that can be overridden is identified.

An example of MA information frame numbered 0001 designating an MA covering a majority of jurisdiction 01234567 (Pinellas County, Fla., USA) and disabling the CPCD 20′ keypad 16b, microphone 16c, speaker 16d, vibrator 16e, display 16f, local wireless transceiver 16i and USB transceiver 16j at an SOM 242 above 10 mph follows:

[(82,51,06.12,1), (82,39,01.57,1),(28,10,23.35,1), (27,36,36.89.1), 01234567, 0001, 1, 1, 10, 0, 000000]

An example of OA information frame numbered 0101 designating an OA covering about 3.5 miles of commuter railroad tracks in jurisdiction 01234568 (Hillsborough County, Fla., USA) and overriding disablement of the CPCD 20′ keypad 16b, microphone 16c, speaker 16d, vibrator 16e, display 16f, local wireless transceiver 16i and USB transceiver 16j follows:

[(82,26,31.58,1), (82,23,24.17,1), (27,57,34.70,1), (27,57,34.20.1), 01234568, 0101, 1, 1, 000000000]

TABLE 2A
MA INFORMATION FRAME FORMAT

| | No. of | | |
|---|---|---|---|
| Description | Digits | Comment or Example | Note |
| West Boundary | 10 | Degrees (3), Minutes (2), Seconds(4), | |
| | | E/W(1) | |
| East Boundary | 10 | Degrees (3), Minutes (2), Seconds(4), | |
| | | E/W(1) | |
| North Boundary | 10 | Degrees (3), Minutes (2), Seconds(4), | |
| | | N/S(1) | |
| South Boundary | 10 | Degrees (3), Minutes (2), Seconds(4), | |
| | | N/S(1) | |
| Jurisdiction Code | 8 | 100,000,000 possibilities | |
| Local MA | 4 | Assigned as needed to cover the | |
| Number | | jurisdiction | |
| Frame Type | 1 | JEM = 0 | 1 |
| Disable Code | 2 | | 2 |
| MSL Code | 2 | 10 miles per hour = 10 | |
| EOS Code | 1 | Enables an EOS alternative | 3 |
| Future Use | 6 | Reserved | |
| TOTAL | 64 | | |

NOTE 1: Designates JEM or JOM or eight for future use.
NOTE 2: Disable code 1 = keypad, microphone, speaker, vibrator, display, wireless transceiver and USB transceiver.
NOTE 3: 0 = EOS detection not allowed. 1 = audio EOS enabled, the DTMF sequence is “E-O-S” and N = 60 seconds. 2 = Bluetooth EOS enabled. 3 = infrared EOS enabled.

TABLE 2B
OA INFORMATION FRAME FORMAT

| | No. of | | |
|---|---|---|---|
| Description | Digits | Comment or Example | Note |
| West Boundary | 10 | Degrees (3), Minutes (2), Seconds(4), | |
| | | E/W(1) | |
| East Boundary | 10 | Degrees (3), Minutes (2), Seconds(4), | |
| | | E/W(1) | |
| North Boundary | 10 | Degrees (3), Minutes (2), Seconds(4), | |
| | | N/S(1) | |
| South Boundary | 10 | Degrees (3), Minutes (2), Seconds(4), | |
| | | N/S(1) | |
| Jurisdiction Code | 8 | 100,000,000 possibilities | |
| Local OA | 4 | Assigned as needed to cover the | |
| Number | | jurisdiction | |
| Frame Type | 1 | JOM = 1 | 1 |
| Override Code | 2 | | 2 |
| Future Use | 9 | Reserved | |
| TOTAL | 64 | | |

NOTE 1: Designates JEM or JOM or future use (8).
NOTE 2: Override code 1 = keypad, microphone, speaker, vibrator, display, wireless transceiver and USB transceiver.

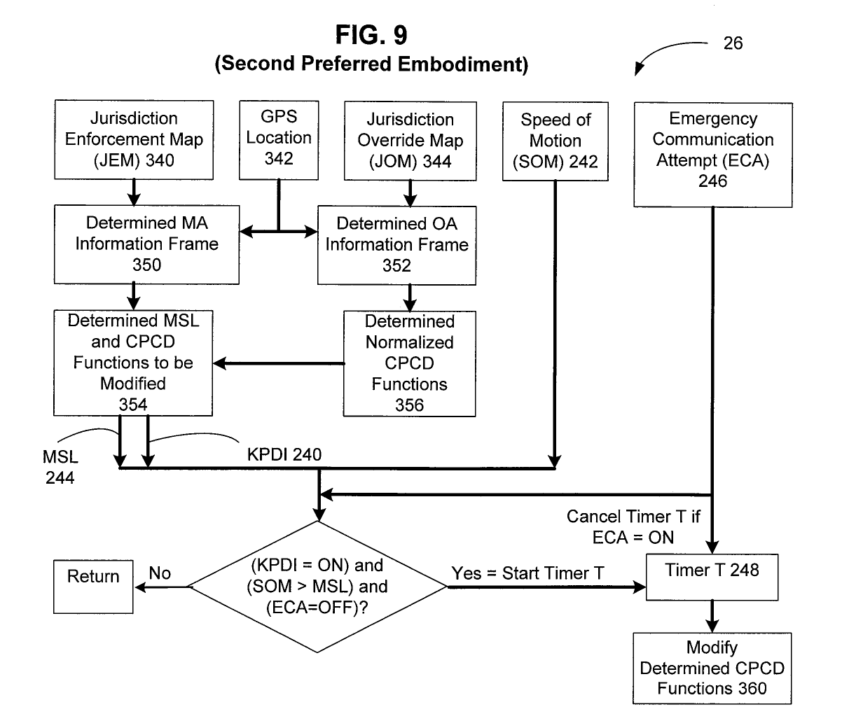

FIG. 9 is a flow diagram illustrating the architecture, functionality, and operation of an exemplary control system 26 of this second preferred embodiment. As shown in FIG. 9, the determined MA information frame 350 is identified. If no MA is determined, then no CPCD function is disabled. An exemplary MA number search and identification is accomplished as follows:
1. The CPCD 20′ GPS location 342 longitude is compared to the West boundary of each MA information frame in the JEM 340. Each MA information frame for which the location longitude is east of the West boundary, if any, is retained, and others are rejected.
2. The CPCD 20′ GPS location 342 longitude is compared to the East Boundary of each above retained MA information frame in the JEM 340. Each MA information frame for which the location longitude is west of the East boundary, if any, is retained, and others are rejected.
3. The CPCD 20′ GPS Location 342 latitude is compared to the North Boundary of each above retained MA information frame in the JEM 340. Each MA information frame for which the location latitude is south of the North boundary, if any, is retained, and others are rejected.
4. The CPCD 20′ GPS location 342 latitude is compared to the South Boundary of each above retained MA information frame in the JEM 340. Each MA information frame for which the location latitude is north of the South boundary, if any, is retained and others are rejected.
5. The surviving MA information frame, if any, is the determined MA information frame 350.
   It is next determined whether the current CPCD 20′ location is within an OA located in the JOM 344 and, if so determined, the determined OA information frame 352 is identified. An exemplary OA information frame search is accomplished as follows:
6. If no MA information frame was determined, then no OA information frame search is attempted.
7. OA information frames with the same Jurisdiction Code as the determined MA information frame 350 are retained, and others are rejected.
8. The CPCD 20′ GPS Location 342 longitude is compared to the West boundary of each above retained OA information frame in the JOM 344. Each OA information frame for which the location longitude is east of the West boundary is retained, and others are rejected.
9. The CPCD 20′ GPS Location 342 longitude is compared to the East Boundary of each above retained OA information frame in the JOM 344. Each OA information frame for which the location longitude is west of the East Boundary is retained, and others are rejected.
10. The CPCD 20′ GPS Location 342 latitude is compared to the North Boundary of each above retained OA information frame in the JOM 344. Each OA information frame for which the location latitude is south of the North Boundary, if any, is retained, and others are rejected.
11. The CPCD 20′ GPS location 342 latitude is compared to the South Boundary of each above retained OA information frame in the JOM 344. Each OA information frame for which the location latitude is north of the South Boundary, if any, is retained and others are rejected.
12. The surviving OA information frame, if any, is the determined OA information frame 352.
   The MSL code and the disable code extracted from the determined MA information frame 350 in block 354 determine MSL and CPCD functions to be disabled 354 , and the override code extracted from the determined OA information frame 352 in block determine normalized CPCD functions 356. In this example, MSL 244 is 10 mph and the disable code and the override code is such that KPDI 240 is ON. SOM 242 and ECA 246 are determined as in the first preferred embodiment. Timer T 248 is started or restarted if (KPDI=ON) and (SOM>MSL) and (ECA=OFF). Keypad 16b operation is disabled by Timer T 248 for T seconds after this condition is met as indicated by modify determined CPCD functions 360 which in this example disables the operation of keypad 16b. An exemplary value of T is 15 seconds. Timer T is turned off when ECA 248 is ON.

The CPCD 20′ of this second preferred embodiment provides for function modification in a geographical area without a SOM requirement by setting MSL 244 to zero.

The second preferred embodiment improves public and personal safety by rapidly disabling distracting and detrimental CPCD functions when the CPCD 20′ motion exceeds an established speed limit specific to the CPCD 20′ geographical location and without the need for communication with or cooperation of the wireless network.

### E. Third Preferred Embodiment—CPCD Function Modification Based Upon External Override Signal

In the third preferred embodiment of the control system 26, the CPCD function modification instructions of the first preferred embodiment (FIG. 4) are retained and augmented such that the CPCD function modification instructions of the first preferred embodiment can be made to be dependent upon the nondetection of an external override signal (EOS) 406 generated external to CPCD 20′ and received by CPCD 20′.

In general, a vehicle capable of mobility and capable of transporting persons is equipped with a signal transmitter that communicates an override signal designed to prevent a CPCD 20′ from modifying any one or more of or all CPCD functions. The signal can be directed to one or more locations inside the vehicle that can be occupied by a nondriver of the vehicle, and the signal is prevented from being directed to one or more driver locations within the vehicle. As a result, those passengers occupying nondriver locations will be permitted to use their respective CPCD 20′ without any CPCD function modification. Moreover, the signal can be one or more of the following examples: an electrical signal, a light signal, and/or an audio signal. In some embodiments, the override signal is encoded and can be decoded by the CPCD. In embodiments where some, but not all, CPCD functions are to be provided with an override, specific signal codes can be allocated to respective specific CPCD functions.

A first example of an EOS implementation includes an external audio signal, and the EOS detector 402 includes the CPCD 20′ microphone 16c with detection code in control system 26. This first type of EOS 406 signal provides, for example, reliable modification override for each CPCD 20′ in the possession of a passenger in a public transportation vehicle, such as a subway or train car.

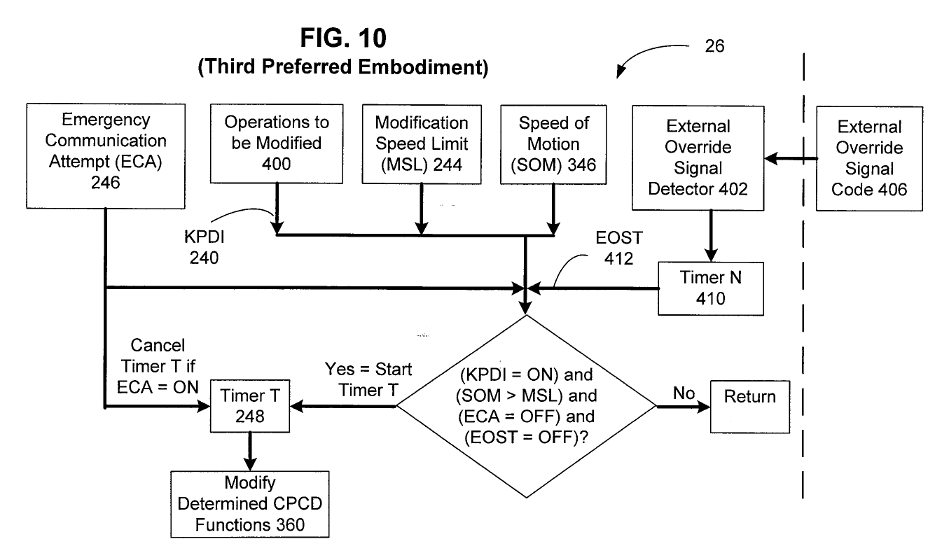

Functionality is controlled by control system 26 and is described with reference to the flow diagram in FIG. 10 and block diagram in FIGS. 3A, 3B. If EOS 406 is present as detected by the control system 26, then the control system 26 advises the operational software 24 to turn on the CPCD microphone 16c via microphone driver 21c, and the digitized received audio is analyzed by the EOS override signal detector 402 software code in the control system 26. The exemplary audio signal is one transmitted by an external audio loud speaker located in the vicinity of CPCD 20′ that conveys from the loud speaker a burst of dual tone multi-frequency (DTMF) signals of the type in common use in dial tone telephone signaling and described in ITU-T recommendation Q.23. Generation of DTMF signals and reliable detection of DTMF signals using, for example, the Goertzel algorithm, even in the presence of other audio signals, is well known by someone skilled in the art. The exemplary transmitted audio burst conveys the DTMF telephone dialed sequence “E-O-S”, as determined by the EOS code in the determined MA information frame. Other DTMF sequences can be established and identified within a MA information frame. The transmitted burst duration is 0.21 seconds, and the burst is transmitted at least every 14 seconds. Upon EOS 406 detection, timer N 410 is started or restarted, generating EOST 412=ON. Time period N is established by the determined MA information sequence as shown Table 2A. N is, for example, 60 seconds. As illustrated with reference to FIG. 10, the CPCD function modification described in the first preferred embodiment is overridden for a time period N after each detection of the EOS. Since the EOS 406 burst is transmitted at least every 14 seconds, normal keypad 16b operation is reliably maintained when CPCD 20′ is in the vicinity of the EOS loud speaker.

In a second example of an EOS implementation, an EOS 406 signal is an addressed and encoded Bluetooth wireless broadcast signal (electromagnetic) inclusive of an override command, and the EOS detector 402 is the local wireless transceiver 16i. Many automobiles today are equipped with a Bluetooth transmitter controlled by suitable software. Such software can be modified to communicate this signal when a party enters a vehicle.

A third example of an EOS implementation utilizes a directional infrared signal (light) of the type used in consumer electronic device remote controls. One or more infrared signal generators coupled to one or more infrared transmitters are situated in the vehicle to interface with one or more CPCD 20′ residing within the vehicle.

FIG. 11 is a block diagram illustrating an exemplary alternative architecture of the CPCD 20′ of FIGS. 3A, 3B wherein this third example can be implemented. This EOS 406 signal and detection thereof provides, for example, reliable function modification override for a CPCD 20′ in the possession of a passenger in a motor vehicle without overriding function modification of a CPCD 20′ in the possession of the driver of the motor vehicle. As shown in FIG. 11, this alternative embodiment, unlike the above described embodiments, utilizes a CPCD 20′ with an infrared detector 16k. Infrared detector 502 detects the encoded infrared EOS. Multiple infrared sensors, strategically located on the housing of the CPCD 20′, may be utilized.

The third preferred embodiment improves public and personal safety by enhancing the public acceptance of the invention by allowing restoral of normal operation of a CPCD 20′ in the possession of passenger of a moving vehicle.

It is envisioned that a legal jurisdiction can mandate, with appropriate laws, if an external override is permitted in a MA within its jurisdiction and, if so, what type or types of override signals are able to be detected. The ability of an EOS 406 to be detected and to override CPCD function modification is determined within each MA information frame by the EOS Code as shown in Table 2A. At any time that an external override is permitted and the permitted EOS 406 is detected, the identified CPCD functions are returned to normal operation for a predefined time period N.

### F. Fourth Preferred Embodiment—CPCD Function Modification Based on Geographical Location

In the aforementioned second preferred embodiment (FIG. 9) of the control system 26, CPCD function modification is dependent upon SOM 242. In the fourth preferred embodiment of the control system 26, the functionality of the second preferred embodiment (FIG. 9) is retained and is supplemented to include modification of one or more selected CPCD functions based on the current geographical location of CPCD 20′ and independent of motion.

Identification of one or more CPCD functions to be enabled is provided in the MA information field, using four of the six future use digits described in the second preferred embodiment (FIG. 9), as shown with reference to Table 3, set forth hereafter.

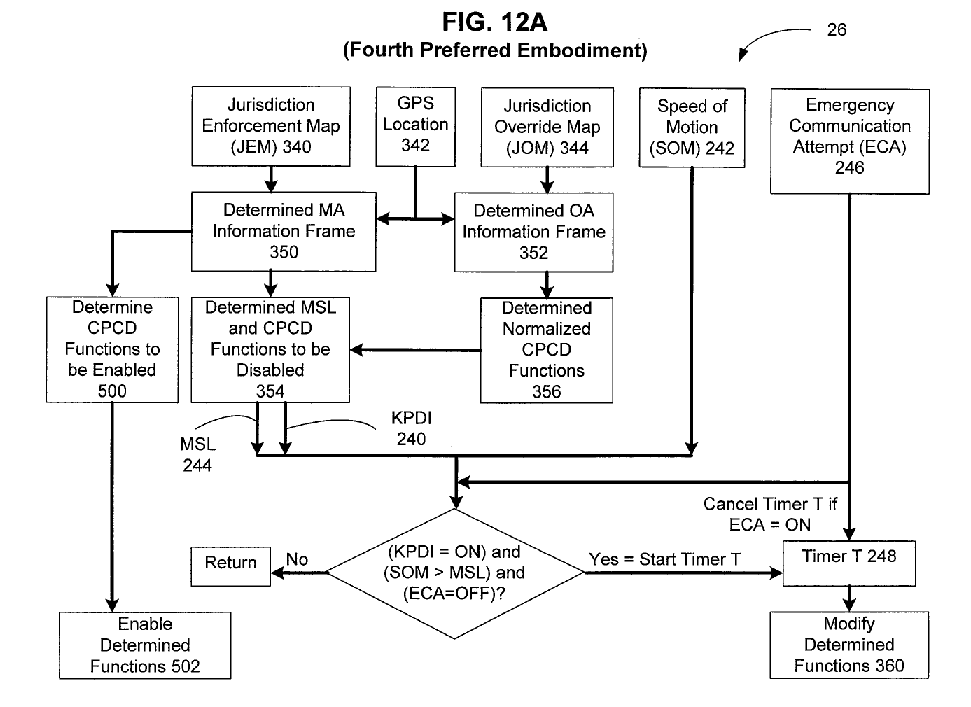

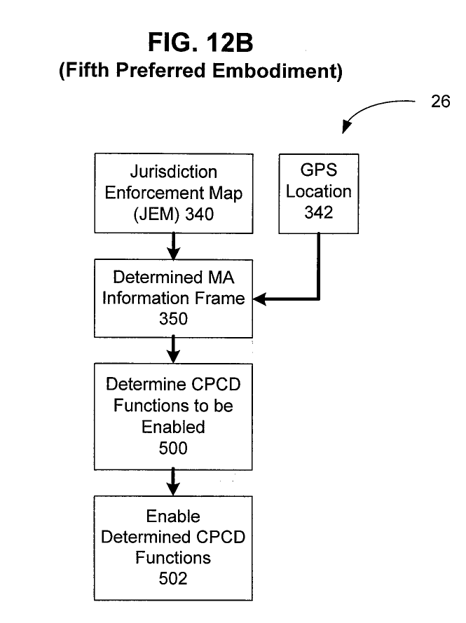

FIG. 12A is a flow diagram of this fourth preferred embodiment exemplifying enablement of a call out and retrieve feature. The determined MA information frame 350 is identified as in the second preferred embodiment (FIG. 9). The determined CPCD function to be enabled, as indicated in block 500, are those identified by the enablement code shown in Table 3. The determined CPCD function is enabled, as indicated in block 502. In this example, enable determined CPCD functions 502 makes the four digit enablement code available to be read by operational software 24 for display to the user of CPCD 20′. By placing a particular wireless telephone call and entering this enablement code, the user of the CPCD 20′ can access information only available in her current location, for example sale information inside a store.

TABLE 3
MA INFORMATION FRAME FORMAT

| | No. of | | |
|---|---|---|---|
| Description | Digits | Comment or Example | Note |
| West Boundary | 10 | Degrees (3), Minutes (2), Seconds(4), | |
| | | E/W(1) | |
| East Boundary | 10 | Degrees (3), Minutes (2), Seconds(4), | |
| | | E/W(1) | |
| North Boundary | 10 | Degrees (3), Minutes (2), Seconds(4), | |
| | | N/S(1) | |
| South Boundary | 10 | Degrees (3), Minutes (2), Seconds(4), | |
| | | N/S(1) | |
| Jurisdiction Code | 8 | 100,000,000 possibilities | |
| Local MA | 4 | Assigned as needed to cover the | |
| Number | | jurisdiction | |
| Frame Type | 1 | JEM = 0 | 1 |
| Disable Code | 2 | | 2 |
| MSL Code | 2 | 10 miles per hour = 10 | |
| EOS Code | 1 | Enables an EOS alternative | 3 |
| Enablement | 4 | | 4 |
| Code | | | |
| Future Use | 2 | Reserved | |
| TOTAL | 64 | | |

NOTE 1: Designates JEM or JOM or eight for future use.
NOTE 2: Disable code 1 = keypad, microphone, speaker, vibrator, display, wireless transceiver and USB transceiver.
NOTE 3: 0 = EOS detection not allowed. 1 = audio EOS enabled, the DTMF sequence is “E-O-S” and N = 60 seconds. 2 = Bluetooth EOS enabled. 3 = infrared EOS enabled.
NOTE 4: Call out and retrieve feature number.

The fourth preferred embodiment supplements other embodiments by providing for modification of certain CPCD functions based on geographical location without regard to motion while providing for modification of other CPCD functions based on motion.

### G. Fifth Preferred Embodiment—CPCD Function Modification Based on Geographical Location

FIG. 12B is a flow diagram illustrating a fifth preferred embodiment of the control system 26. The fifth preferred embodiment is essentially a variation of the fourth preferred embodiment (FIG. 12A) of the control system 26 wherein all CPCD function disablement instructions are omitted. When CPCD 20′ is located in JEM 340, then the determined CPCD functions to be enabled 500 are derived from the determined MA information frame 350 based on GPS location 342. An example of an enabled function is the unsolicited audible transmission or visual display of an advertisement or public announcement that had been previously stored in CPCD 20′ for use in the MA without communication with or cooperation with wireless network 202 and without prompting by the user of the CPCD 20′.

The fifth preferred embodiment provides for modification of certain CPCD functions based on geographical location without regard to motion.

### H. Sixth Preferred Embodiment—CPCD Function Modification Supplemented with Use Of GPS and Map Data

In a sixth preferred embodiment of the control system 26, the first preferred embodiment (FIG. 4) is augmented with the current geographical location of the CPCD 20′ obtained from the GPS data and map data 25 such that selected CPCD functions are modified based upon the SOM and the location of the CPCD 20′ on a map. As an example, the control system 26 can be configured so that CPCD functions are disabled when the SOM exceeds the MSL at times when the CPCD 20′ is located within a designated location, such as a designated roadway (DR). Nonlimiting examples of a DR are a highway, a waterway, and a railroad. DRs are identified in which disablement of the one or more CPCD functions is provided under conditions established for each DR. The augmentation is implemented in operational software 24.

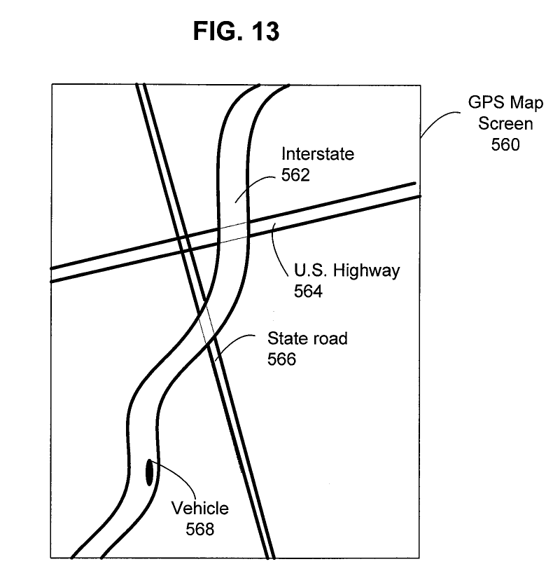

A DR is described with reference to an example shown in FIG. 13. GPS map screen 560 is an exemplary illustration of a portion of the complete GPS and map digital information contained in operational software 24. GPS map screen 560 represents the roadways in the vicinity of the current GPS location of mobile vehicle 568 carrying CPCD 20′. Interstate 562 is an exemplary illustration of digital information representing a U.S. Interstate roadway. U.S. Highway 564 is an exemplary illustration of digital information representing a U.S. highway. State road 566 is an exemplary illustration of digital information representing a state roadway. Motor vehicle 568 is a vehicle located on Interstate 562 in which CPCD 20′ is located. In the example illustrated in FIG. 13, Interstate 562 is identified as a DR. Interstate 562 remains designated as a DR even if the displayed GPS and map information changes when the current location of CPCD 20′ changes.

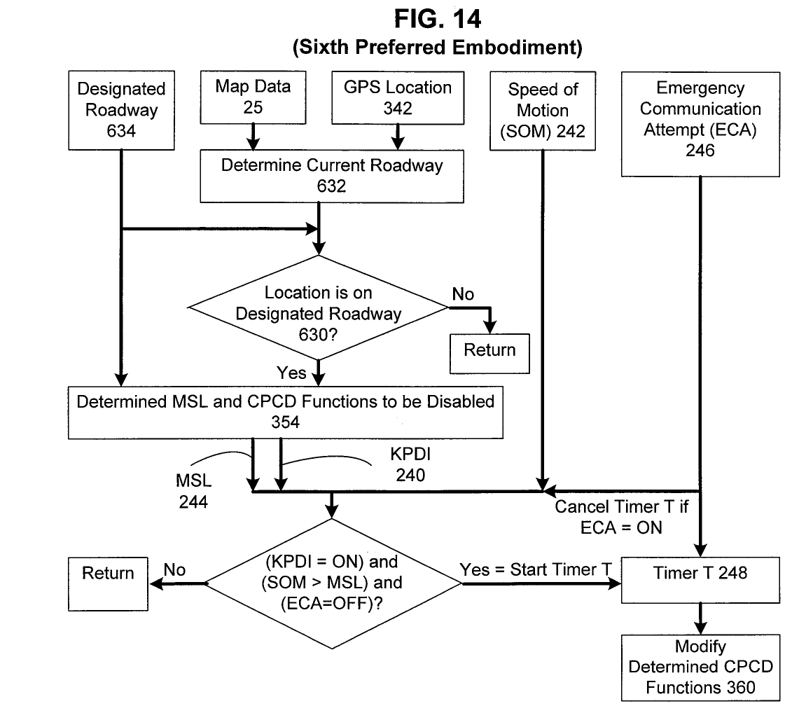

FIG. 14 is a flow diagram of this sixth preferred embodiment of the control system 26 exemplifying the function disablement functionality for the keypad 16b. Information describing designated roadway 634, an MSL, and functions to be modified are provided in block 634. The current GPS location 342 is compared to map data 25 in block 632 to determine on which roadway, if any, CPCD 20′ is located. If the determined roadway matches designated roadway 634, then MSL 244 and KPDI 240 are, in this example, selected in block 354 from designated roadway information 634. In this example, MSL 244 is 10 mph and KPDI 240 is ON. SOM 242 and ECA 246 are determined as in the first embodiment. Timer T 248 is started or restarted if (KPDI=ON) and (SOM>MSL) and (ECA=OFF). The operation of keypad 16b is disabled by Timer T 248 for a predefined time duration, T seconds, after this condition is met as indicated by modify determined CPCD functions 360 which in this example disables the operation of keypad 16b. An exemplary value of T is 15 seconds. Timer T is turned off when ECA 248 is ON. This sixth preferred embodiment can provide for CPCD function disablement on a designated roadway without an SOM requirement by setting MSL 244 to zero.

The sixth preferred embodiment improves public and personal safety by rapidly disabling distracting and detrimental CPCD functions when the CPCD 20′ motion exceeds an established speed limit specific to the CPCD 20′ geographical location on a designated roadway and without the need for communication with or cooperation of the wireless network.

### I. Seventh Preferred Embodiment—CPCD Function Modification Based on Acceleration and/or Deceleration

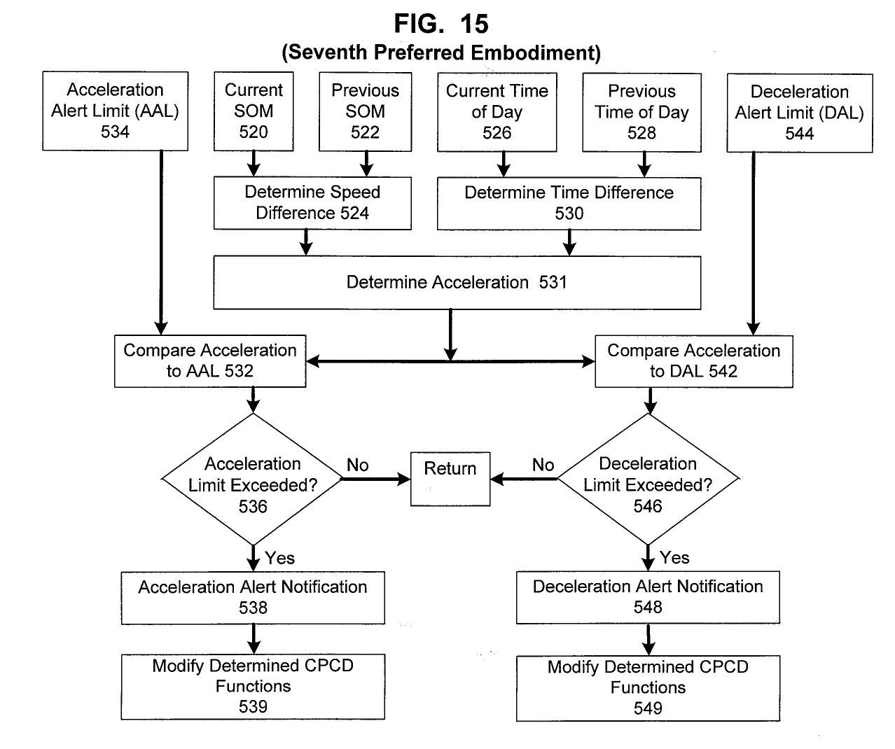

FIG. 15 is a flow diagram of a seventh preferred embodiment of the control system 26 wherein CPCD function modification is based on acceleration and/or deceleration of the CPCD 20′. Acceleration is the positive rate of change of SOM, whereas deceleration is the negative rate of change of SOM.

In the seventh preferred embodiment, an AAL 534 and a deceleration alert limit (DAL) 544 are provided to and stored in software 22, for example, by download entry or keypad 16b entry. Exemplary values of AAL 534 and DAL 544 are +6 mph/sec and −30 mph/sec, respectively. The current SOM 520 is compared to a previous SOM 522 to determine speed difference 524. The current time of day (TOD) 526 corresponding to SOM 520 is compared to the previous TOD 528 corresponding to SOM 522 to determine time difference 530. The software 22 has an on-board clock for determining TOD and/or receives time information from the wireless network that is directly or indirectly indicative of TOD. Acceleration 531 is determined by dividing the determined speed difference 524 by determined time difference 530. If the determined acceleration 531 is arithmetically positive, then acceleration 531 is compared to AAL 534.

If acceleration 531 is more positive than AAL 534, then AAL 534 is exceeded. Furthermore, an acceleration alert notification 538 is generated and/or one or more CPCD functions can be modified, as indicated in block 539. The alert notification 538 can be produced for the user on any of the I/O devices 16, for example but not limited to, the speaker 16d, the vibrator 16e, or the display 16f. The alert notification 538 can also be sent to a remote communication device.

If the determined acceleration 531 is arithmetically negative, then acceleration 531 is compared to DAL 544. If acceleration 531 is more negative than DAL 544, then DAL 544 is exceeded. Furthermore, a deceleration alert notification 548 is generated and/or one or more CPCD functions can be modified, as indicated in block 549. The alert notification 548 can be produced for the user on any of the I/O devices 16. The alert notification 548 can also be sent to a remote communication device.

The seventh preferred embodiment improves public and personal safety by identifying potentially dangerous levels of acceleration and/or deceleration, providing resulting modification of a CPCD function and providing an alert from the CPCD 20′.

### J. Eight Preferred Embodiment—CPCD Alert Messages Based on Speed, Acceleration, and/or Deceleration

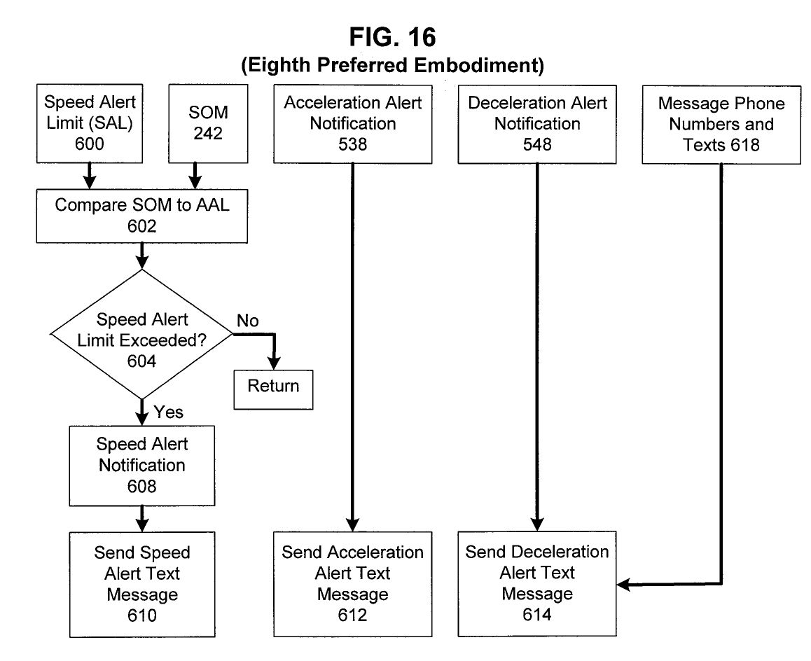

FIG. 16 is a flow diagram of an eighth preferred embodiment of the control system 26 wherein one or more alert messages are automatically sent to a remote communication device or communications service by the CPCD 20′ based on exceeding a speed alert limit (SAL) and/or exceeding an AAL and/or exceeding a DAL.

With reference to the example of FIGS. 16, an SAL 600, an AAL 534, and a DAL 544 are provided to and stored in software 22, for example, by download entry or keypad entry. Exemplary values of SAL 600, AAL 534 and DAL 544 are 75 mph, +6 mph/sec and −30 mph/sec, respectively. Message telephone numbers and texts 618 are provided in software 22, for example, by download entry or keypad entry. An example of a message telephone number and text to be sent in response to the CPCD exceeding the SAL 600 is: “555-555-1234, daughter is exceeding 75 mph.” An example of a message telephone number and text to be sent in response to the CPCD 20′ exceeding the DAL 544 is: “911, severe deceleration detected-potential collision.” An example of a message telephone number and text to be sent in response to the CPCD 20′ exceeding the AAL 544 is: “555-555-1234, son driving erratically.”

Acceleration alert notification 538 and deceleration alert notification 548 are generated as described previously in connection with FIG. 15. The current SOM 242 is compared to the SAL 600 in block 602. If SOM 242 exceeds ML 600, then speed alert notification 608 is generated.

Upon generation of speed alert notification 608, speed alert text message 610 is sent. Upon generation of acceleration alert notification 538, acceleration alert text message 612 is sent. Upon generation of deceleration alert notification 548, deceleration alert text message 614 is sent.

In an alternative embodiment, one or more CPCD functions are modified before, during, or after an alert notification 538, 548 is generated.

The eighth preferred embodiment of FIG. 16 improves public and personal safety by identifying potentially dangerous levels of speed, acceleration, and/or deceleration and sending corresponding messages to authorities or other selected parties.

### K. Ninth Preferred Embodiment—CPCD Function Modification Based Upon Time Information And Geographical Location

In a ninth preferred embodiment, one or more CPCD functions are modified based upon time information (e.g., the DOW, the TOD, etc.) and the location of the CPCD 20′. The time information is determined based upon an on-board clock and/or is determined based upon time information communications from the wireless network if the CPCD 20′ is interfaced to one.

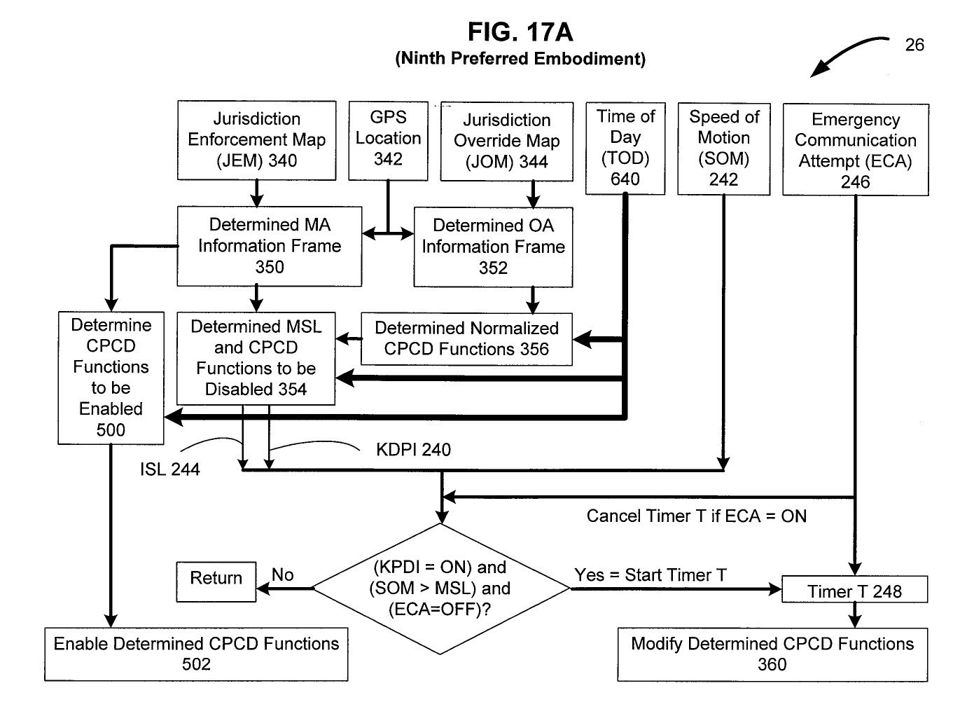

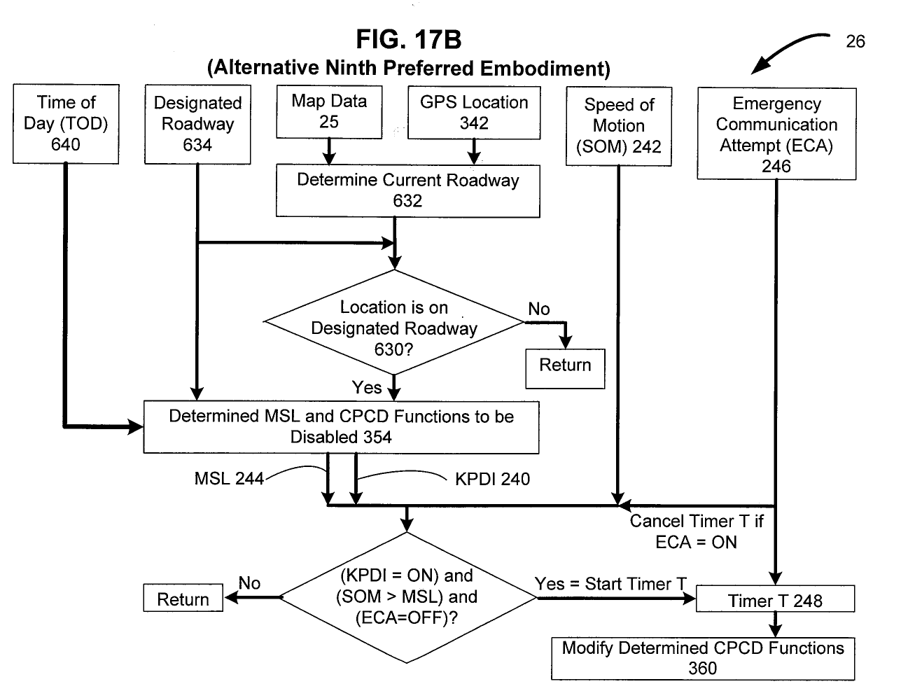

FIG. 17A is a flow diagram of a ninth preferred embodiment of the control system 26 wherein the CPCD functions to be modified are based, at least in part, upon the TOD 640, the GPS location 342 within a MA, and the GPS location 342 within an OA. This ninth preferred embodiment modifies, based on the DOW and the TOD, the operation of the fourth embodiment described elsewhere as illustrated in FIG. 12A.

Three future use digits of the MA information frame format described in Table 2A are designated as DOW digits to identify any DOWs for which the operation of the determined MSL and functions to be disabled block 354 may be modified. Two start-hour digits and two stop-hour digits are added to the MA information frame format described in Table 2A to identify a time period in a day in which the determined MSL and functions to be disabled block 354 may be modified. As is known to one skilled in the art, TOD 640 is continuously available in operational software 24 of the CPCD 20′. TOD 640 is periodically read from operational software 24, written into control system 26, and compared in block 354 to the DOWs, start-hour and stop-hour information of determined MA information frame 350. The TOD 640, DOW digits, start-hour digits and stop-hour digits together permit modification of the operation of the functions to be disabled block 354. The modification in this ninth preferred embodiment reduces the MSL 244 by 50% Monday through Friday from 7AM to 6 PM, further improving public safety during slow, heavy rush hour traffic.

The ninth preferred embodiment described in FIG. 17A permits modification of the operation of determine CPCD functions to be enabled 500 and determine normalized functions 356. The CPCD 20′ of this ninth preferred embodiment provides for day of week (DOW) and TOD function modification in a geographical area without a SOM requirement by setting MSL 244 to zero.

FIG. 17B is a flow diagram of a variation of the ninth preferred embodiment (FIG. 17A) of the control system 26 wherein determined MSL and CPCD functions to be modified are based, at least in part, upon the TOD 640 and the GPS location 342 on a designated roadway 634. This variation of the ninth preferred embodiment modifies, based on the DOW and the TOD, the operation of the sixth embodiment (FIG. 14).

Three future use digits of the MA information frame format described in Table 2A are designated as DOW digits to identify any DOWs for which the operation of the determined MSL and functions to be disabled block 354 may be modified. Two start-hour digits and two stop-hour digits are added to the MA information frame format described in Table 2A to identify a time period in a day in which the determined MSL and functions to be disabled block 354 may be modified. As is known to one skilled in the art, TOD 640 is continuously available in operational software 24 of the CPCD 20′. TOD 640 is periodically read from operational software 24, written into control system 26, and compared in block 354 to the DOWs, start-hour and stop-hour information of determined MA information frame 350. The TOD 640, DOW digits, start-hour digits and stop-hour digits together permit modification of the operation of the functions to be disabled block 354. The modification example in this variation of the ninth preferred embodiment reduces the MSL 244 by 50% Monday through Friday from 7 AM to 6 PM, further improving public safety during slow, heavy rush hour traffic.

The ninth preferred embodiment improves upon the other embodiments by providing for conditions for modifying CPCD functions to be based on time information, such as the DOW and TOD.

### L. Tenth Preferred Embodiment—CPCD Function Modification Based Upon Time Information and Speed Of Motion (SOM)

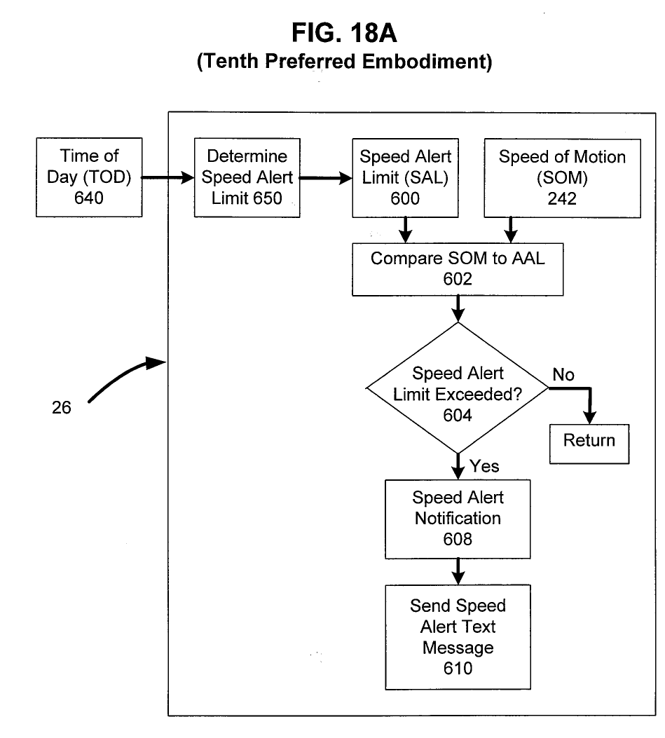

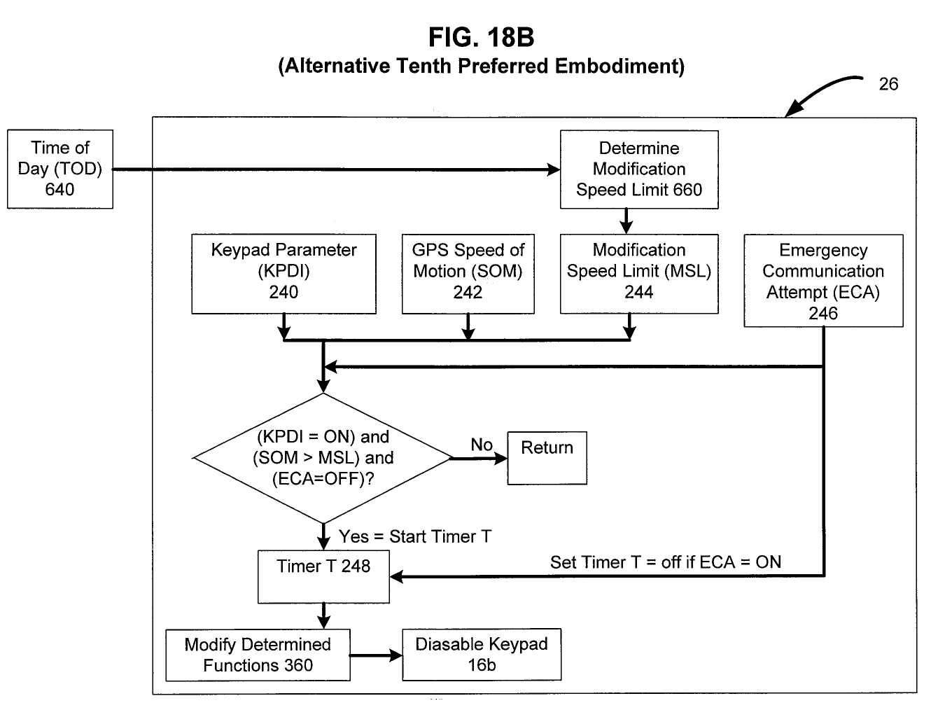

FIG. 18A is a flow diagram of a tenth preferred embodiment of the control system 26 of CPCD 20′ wherein speed alert limit 600, described in other embodiments, is based TOD 640 and the GPS SOM 242. Although not limited to this implementation, in this embodiment, TOD 640 is inclusive of both DOW and TOD. Other implementations could use one or the other or some other type of time information.

Three future use digits of the MA information frame format described in Table 2A are designated as DOW digits. Two start-hour digits and two stop-hour digits are added to the MA information frame format described in Table 2A to identify, in conjunction with the DOWs, an alert time period. In the example illustrated in FIG. 18A, TOD 640 is used in determine speed alert limit block 650 to select one of two values of speed alert limit 600. As is known to one skilled in the art, TOD 640 is continuously available in CPCD 20′ operational software 24. TOD 640 is periodically read from operational software 24, written into control system 26, and compared in determine speed alert limit block 650 to the DOWs, start-hour, and stop-hour information. The SAL 600 is set to be 4 mph during the alert time period and 50 mph otherwise, as nonlimiting examples. The SAL 600 could be preset to any suitable value by a user who has authority to set and change user preferences. The applicable user preferences can be password protected by such user. As described in connection with the eighth preferred embodiment (FIG. 16), control system 26 will send a speed alert text message 610 when the SOM 242 exceeds the SAL 600.

In one application example, the CPCD 20′ alert time period is selected to be 7 PM to 7 AM on all DOWs, covering night time hours, as a nonlimiting example. The alert time period can be preset to any suitable time period or a plurality of time periods by the user who has the password(s) to set and change user preferences.

As an example of an application, a driver who is prohibited from driving a motor vehicle during certain time periods and/or on certain DOWs can be given the CPCD 20′ to carry in order to monitor such driver. In this application, the driver should not have the appropriate password(s) to change the applicable user preferences associated with the CPCD 20′. In this application, the driver is prohibited from riding in a motor vehicle during the night time hours and is prohibited from riding in a vehicle at other times at speeds above 50 mph. If the driver violates the foregoing prohibitions, then the CPCD 20′ in the possession of the driver will cause a text message or other communication to be sent to a remote communication device to alert a party, such as the user of the CPCD 20′ that set the user preferences to implement the prohibitions.

FIG. 18B is a flow diagram of an alternative tenth preferred embodiment of the control system 26 of the CPCD 20′ wherein MSL 244, described in other embodiments, is based on TOD 640. In this embodiment, TOD 640 is inclusive of both DOW and TOD. In the example illustrated in FIG. 18B, TOD 640 is used in determine modification speed limit block 660 to select one of two values of MSL 244. The MSL 244 is preset to be 5 mph during the alert time period and 15 mph otherwise, as examples. As described in connection with the first preferred embodiment (FIG. 4), keypad 16b is disabled if the SOM 242 exceeds 5 mph during the alert time period or 15 mph otherwise.

In one application example, among many other possible examples, the CPCD 20′ alert time period is selected to be 7 AM to 6 PM on Monday through Friday, covering week day business hours. A user of CPCD 20′ will have CPCD keypad 16b functionality disabled when traveling at a SOM above 5 mph during rush hour and above 15 mph at other times.

### M. CPCD Function Modification Based Upon Information Received from a Vehicle Control System

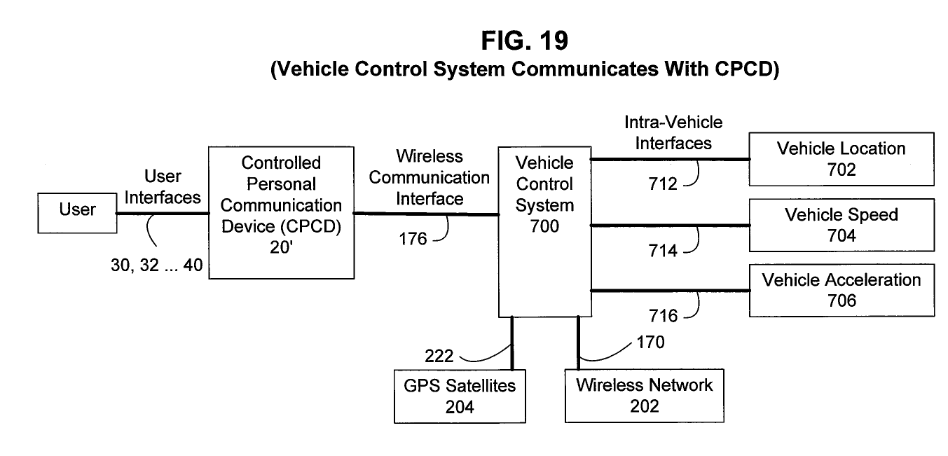

In other embodiments, one or more of the CPCD location, SOM, and acceleration can be determined by a system that is remote or external to the CPCD 20′ and this information is communicated to the CPCD 20′ for processing. FIG. 19 is a block diagram of one such embodiment wherein the location, SOM, and acceleration of the CPCD 20′ are determined remotely or external to CPCD 20′ and communicated to CPCD 20′.

Vehicle location 702 is determined within a mobile vehicle in which CPCD 20′ is located. Determination may be based on GPS location, roadway embedded information sensing, or any other means. Vehicle location 702 is communicated to the vehicle control system 700 by intra-vehicle interface 712 which may be wired, a wired bus, a wireless bus, or any other means.

Vehicle speed 704 is determined within the vehicle in which CPCD 20′ is located. Determination may be based on GPS location change and time change, roadway embedded information sensing, or any other means. Vehicle speed 704 is communicated to the vehicle control system 700 by intra-vehicle interface 714 which may be wired, a wired bus, a wireless bus, or any other means.

Vehicle acceleration 706 is determined within the vehicle in which CPCD 20′ is located. Determinations may be based on GPS location changes and time changes, roadway embedded information sensing, airbag sensing systems, or any other means. Vehicle acceleration 706 is communicated to the vehicle control system 700 by intra-vehicle interfaces 716, which may be implemented via, for example, a wired bus, a wireless bus, or any other means.

Vehicle location 702, vehicle speed 704, and vehicle acceleration 706 are received by vehicle control system 700 and communicated to CPCD 20′ via wireless communication interface 176. CPCD 20′ receives the vehicle location 702, vehicle speed 704 and vehicle acceleration 706 and transfers said information to CPCD control system 26 (as illustrated in FIG. 3B and described elsewhere). CPCD control system 26 converts vehicle location 702 to GPS location 342, vehicle speed 704 to SOM 242 and vehicle acceleration 706 to determine acceleration 531. Control system 26 may proceed with logic associated with any of the other embodiments described herein.

As an alternative to the direct communication between CPCD 20′ and wireless network 202 described above, CPCD 20′ may instead be coupled to wireless network 202 via the vehicle control system 700 as illustrated in FIG. 19. Vehicle control system 700 can contain a network wireless transceiver comparable to CPCD network wireless transceiver 16g and exchanges information between the wireless transceiver and CPCD 20′ over wireless communication interface 176.

As an alternative to the direct reception of GPS signals and information by CPCD 20′ described previously in this document, CPCD 20′ may instead be coupled to GPS satellites 204 via the vehicle control system 700 as illustrated in FIG. 19. Vehicle control system 700 contains a GPS receiver comparable to CPCD GPS receiver 16h and transfers information between the GPS receiver and CPCD 20′ over wireless communication interface 176.

### N. Eleventh Preferred Embodiment—CPCD Function Modification Based Upon Wireless Interface With Hands-Free Equipment

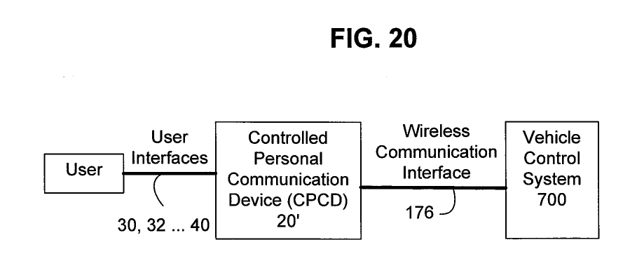

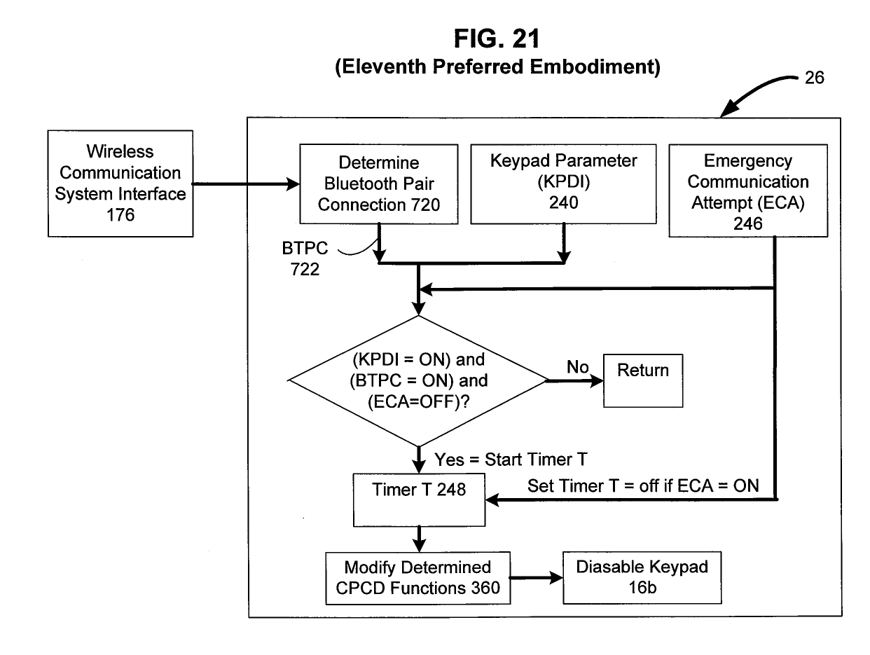

FIG. 20 is a block diagram illustrating an embodiment wherein the CPCD 20′ of FIGS. 3A, 3B is interfaced via a wireless interface, such as the Bluetooth standard format interface, to hands-free equipment associated with a mobile vehicle, for example, a vehicle control system 700 of a motor vehicle to be driven on a roadway or a water vehicle to be driven on a waterway. FIG. 21 is a flow diagram of an eleventh preferred embodiment of the control system of FIGS. 3A, 3B that can be implemented in the CPCD 20′ of FIG. 20. In general, when the control system 26 of the CPCD 20′ determines that the CPCD 20′ is communicatively coupled to hands-free equipment to enable a user to communicate over the CPCD 20′ in a safe hands-free manner, then the control system 26 will enable one or more CPCD functions to permit the hands-free operation of the CPCD 20′, while disabling one or more other CPCD functions that are considered dangerous during operation of the motor vehicle. The logical decision can also be made dependent upon motion of the CPCD 20′, if desired, in alternative embodiments.

In this regard, many motor vehicles are now being provided with a Bluetooth interface that can connect the wireless telephone with a vehicle control system that controls a vehicle microphone and speaker, so that the driver can communicate over the telephone, in a hands free manner, by talking through the vehicle microphone and listening to the vehicle speaker. The control system 26 can be designed to prevent a driver of the motor vehicle from communicating text messages and other CPCD functions, if desired, by disabling such CPCD functions, while enabling the driver to communicate over the wireless telephone with hands free operation by way of the microphone and speaker associated with the motor vehicle and the Bluetooth interface to/from the wireless telephone.

With reference to FIG. 21, the control system 26 monitors for activity on the Bluetooth interface and the keypad 16b, and also monitors for ECAs on the keypad 16b. These inputs are provided to the control system 26 from the software 22. If (KPDI 240=ON) and (BTPC=ON) and (ECA 246=OFF), then timer T 248 is started and set to ON. The operation of keypad 16b is disabled when timer T 248 is ON. Time T can be any suitable value. An exemplary value of time T is 15 seconds. At any time that ECA 246=ON, timer T 248 is set to OFF.

Next, the control system 26 determines which CPCD functions are modified at block 360. For example, if applicable, the following CPCD functions are disabled: image display, 16f, microphone 16c, speaker 16d, camera 16a, text message creation, text message transmission, text message reception, email creation, email reception, image creation, image reception, Internet browsing, gaming, keypad 16b (as indicated at block 16b). Moreover, the following CPCD functions are left enabled to permit the hands-free operation of the CPCD 20′ by the user: voice call out, voice call answer, ring signal operation, communication signal transmission, and communication signal reception. The aforementioned CPCD functions operate in conjunction with the vehicle control system 700.

When the Bluetooth interface terminates (i.e., when BTPC=OFF), then CPCD functions are restored by the control system 26 to their normal operation.

### O. Installation of Control System

The control system 26 of the CPCD 20′, when implemented in the form of software as in the preferred embodiments, can be installed, modified, amended, and appended by software downloading. Software downloading to the CPCD 20′ may be performed to install the control system 26, to correct a flawed operation, to improve performance, to change operations, to introduce new operations, to change parameters, and to enable previously disabled operations. Software downloading can replace all or part of existing software code with new code and can add new software code. Exemplary downloading techniques that can be applied in connection with the control system 26 are described in U.S. Pat. Nos. 5,778,234 and 6,131,159, which are incorporated herein by reference in their entirety. Installation, modification, amendment, and appending of control system 26 (as well as operational software 24) may also be accomplished by utilization by the operational software 24 of information located in an external memory card inserted into external memory interface 162.

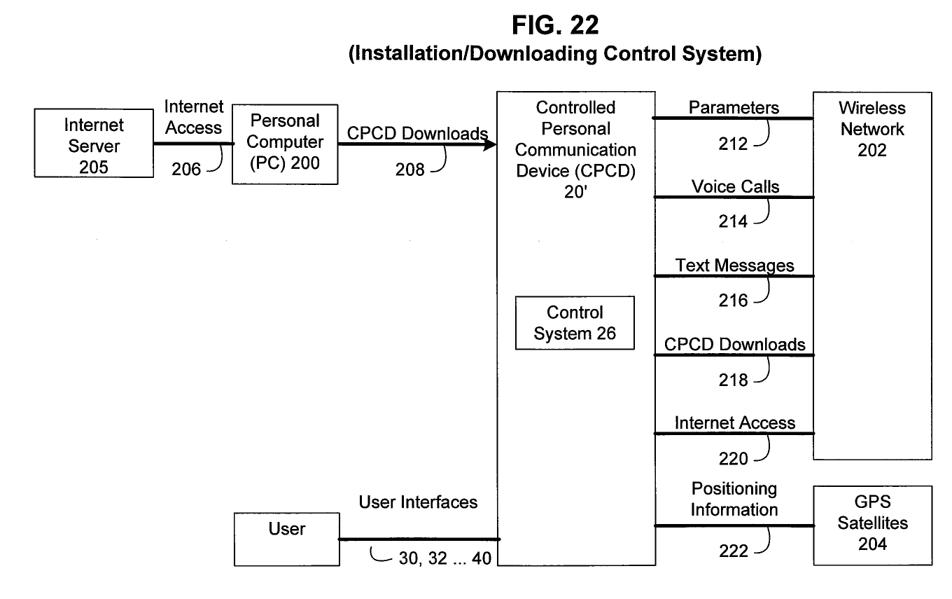

With reference to FIG. 22, software downloading of the control system 26 to the CPCD 20′ can be accomplished several ways. As a first software downloading example, the control system 26 to be downloaded into the CPCD 20′ can first be collected or downloaded into PC 200 which is connected by the internet access 206 to a website containing the control system 26. Once the control system 26 has been downloaded and is available in the PC 200, the control system 26 can be downloaded into the CPCD 20′ over communication path 208, for example, via the local wireless transceiver 16i (FIGS. 3A, 3B) or the USB transceiver 16j (FIGS. 3A, 3B).

As a second software downloading example, the control system 26 to be downloaded into the CPCD 20′ can be retrieved from the wireless network 202. By following wireless network 202 instructions, the control system 26 can be downloaded into the CPCD 20′ via communication path 218, for example, by the techniques described in U.S. Pat. Nos. 5,778,234 and 6,131,159, the disclosures of which are incorporated herein by reference in their entirety.

As a third software downloading example, the control system 26 to be downloaded into the CPCD 20′ can be sent to the CPCD 20′ by the wireless network 202 at the time of power on and connection to the wireless network 202 via communication path 218.

As a fourth software downloading example, new software to be downloaded can be retrieved by the CPCD 20′ by connection to an Internet website containing the new software, such Internet connection being made through internet access 220 provided by the wireless network 202.

As a fifth software downloading example, control system 26 located on an external memory card inserted into external memory interface 162 can be accessed and retrieved by operational software 24.

### P. Methods of Doing Business

Furthermore, the present invention provides methods of doing business. One method, among others, involves distributing control software to enable implementation of a CPCD 20′ for a fee. The method involves the steps of (a) communicatively coupling a PCD and a computer server over one or more networks (the internet, the cellular telephone network, etc.); (b) engaging in a communication session involving the transfer of the control system 26 from the server to the PCD, the control software designed to modify operation of a CPCD function of the PCD based at least in part upon the motion and/or location of the PCD; and (c) charging a fee for communicating the control system 26 to the PCD in order to implement the CPCD 20′. The fee could be charged by the network service provider, the software supplier, or other entity.

The foregoing method of doing business can be implemented in an automated manner, if desired, by employing a computer system that is programmed to perform the foregoing steps. In this embodiment, the computer system is interfaced to the Internet and is accessible, for example, by a wireless PCD (via the wireless network in conjunction with the Internet). The fee could also be charged by the computer system and paid by the user of the PCD as part of the control system download transaction, for example, via credit card, PayPal, etc.

A second method of doing business involves licensing rights to generation of override signals for a fee.

A third method of doing business involves licensing rights to provide audible or visual advertisements to the user of CPCD 20′ based on GPS location. The method involves the steps of: (a) charging a fee for each announcement targeting a MA; downloading said announcement to CPCD 20′; determining CPCD 20′ is located in MA; audibly or visually transmitting the announcement from CPCD 20′ to the user without prompting by the user of CPCD 20′ and without further cooperation of a wireless network. The method can provide a single announcement. The method can provide repeated, periodic announcements. The repeated announcements may also be limited to a time period.

### Q. Alerts

One or more alerts to the user when a CPCD function is modified can be implemented in embodiments of the control system 26. For example, with reference to the first preferred embodiment of FIG. 4, an alert to the user could be initiated when the operation of the keypad 16b is modified. The alert can be in the form of, for instance, a message sent to the display 16f, an audible signal sent to the speaker 16d, and/or a vibration signal sent to the vibrator 16e. Furthermore, the alert may be communicated to a remote communication device, if desired.

One or more alerts to the user can also be generated when an override signal is received by the CPCD 20′.

The control system 26 of the CPCD 20′ can also be designed to produce alerts based, at least in part, upon motion (without modification of CPCD functions).

### R. User Preferences

In some embodiments, a suitable user interface can be provided to enable a user of the CPCD 20′ to input user preferences that define (a) conditions when the control system 26 modifies operation of one or more CPCD functions, (b) the one or more CPCD functions to be modified, and/or (c) the type of modification for each CPCD function (e.g., enable, disable, change operation of in some way, etc.). In this regard, a user interface module is incorporated in the control system 26 for this purpose. The user and this user interface module can communicate, for instance, via the keypad 16b, speaker 16d, and display 16f. User preferences can be protected, in whole or in part, by suitable password security settings and software.

In a first example, reference is made to FIG. 4. The CPCD 20′ menu is supplemented to include “Safety” settings whereby the user can select a MSL and select CPCD functions to be disabled when the SOM exceeds MSL. When the CPCD 20′ SOM exceeds MSL, the selected CPCD functions will become inoperative, irrespective of other conditions.

In a second example, reference is made to FIG. 10. The menu of CPCD 20′ is supplemented to include “Safety” settings whereby the user can select an MSL, select features to be disabled when the SOM exceeds MSL, and select responsiveness to one or more external override signals. When the SOM of the CPCD 20′ exceeds the MSL, then the selected CPCD functions will become inoperative, except upon reception of a selected override signal.

In a third example, reference is made to FIG. 16. The menu of CPCD 20′ is supplemented to include “Safety” settings whereby the user can predefine or select an SAL, an AAL, a DAL, and three associated alert messages as described in the eighth preferred embodiment (FIG. 16). When CPCD 20′ exceeds any of the selected limits, then the corresponding message will be sent to the user and/or to a remote communication device.

Furthermore, a suitable user interface can also be provided to enable a user of the CPCD 20′ to input user preferences that define (a) conditions when the control system 26 generates an alert, and (b) the type of alert that is generated. In this regard, a suitable user interface module is incorporated in the control system 26 for this purpose. The user and this user interface module can communicate, for instance, via the keypad 16b, speaker 16d, and display 16f.

### S. Other Variations And Embodiments

While various embodiments of the present invention have been described, it will be apparent to those of ordinary skill in the art that many more embodiments and implementations are possible that are within the scope of this present invention, as protected by the appended claims.

For example, in the preferred embodiments, a GPS receiver 16h within CPCD 20′ is configured to sense signals to determine the location of the GPS receiver 16h relative to a predetermined reference point. However, the use of other types of position/location determination systems (having components that are local to and/or remote from the CPCD 20′) are also possible. For example, other types of position/location determination systems that may be used include, but are not limited to, GLONASS, LORAN, Shoran, Decca, TACAN, radar, traffic system monitoring, a system for monitoring vehicle stops along a route, or any other of numerous possible tracking systems or combinations thereof. When a position/location determination system other than the GPS is used, the position/location values may be different. A location value can be any value or set of values that may be used to determine a location of a point on the Earth or within the Earth's atmosphere. This value may be a coordinate value (i.e., grid value), polar value, vector value, time-distance value, or any other type of value or values known in the art for indicating locations of points.

1. A controlled personal communication device (CPCD), comprising:
means for determining motion information associated with the CPCD; and
means for modifying operation of a CPCD function based at least in part upon the motion information.

2. The CPCD of claim 1, wherein the CPCD function is at least one of the following: keypad, image display, microphone, speaker, camera, voice call out, voice call answer, text message creation, text message transmission, text message reception, email creation, email reception, image creation, image reception, Internet browsing, gaming, ring signal operation, communication signal transmission, and communication signal reception.

3. The CPCD of claim 1, wherein the modifying means disables a communication function based upon the motion information and a predetermined threshold for the motion information.

4. The CPCD of claim 3, further comprising a means for re-enabling the communication function when a user attempts an emergency call so that the emergency call can be made by the user via the communication function.

5. The CPCD of claim 1, further comprising a means for receiving a CPCD function requirement associated with a legal jurisdiction and wherein the modifying means modifies the CPCD function based upon the legal jurisdiction requirement in addition to the motion information.

6. The CPCD of claim 1, wherein the determining means further comprises a GPS receiver and a means for computing speed based upon measured GPS information and wherein the motion information is indicative of speed.

7. The CPCD of claim 1, wherein the determining means further comprises a GPS receiver and a means for computing acceleration based upon measured GPS information and wherein the motion information is indicative of acceleration.

8. The CPCD of claim 1, further comprising:
a GPS receiver for determining location information;
wherein the modifying means modifies the CPCD function based, not only upon the motion information, but also the location information.

9. The CPCD of claim 8, further comprising:
means for accessing map information;
wherein the modifying means modifies the CPCD function based, not only upon the motion information and location information, but also the map information.

10. The CPCD of claim 1, further comprising:
a GPS receiver for determining location information;
means for determining a legal jurisdiction; and
wherein the modifying means modifies the CPCD function based, not only upon the motion information, but also the legal jurisdiction.

11. The CPCD of claim 1, further comprising:
a clock for determining time information;
a GPS receiver for determining location information; and
wherein the modifying means modifies the CPCD function based, not only upon the motion information, but also the time information.

12. The CPCD of claim 1, further comprising:
means for determining that the CPCD function should be exempted from modification; and
means for overriding an attempt by the modifying means to modify the CPCD function in order to permit normal operation of the CPCD function.

13. The CPCD of claim 1, further comprising a user interface means for permitting input of user preferences that define at least one of the following: when the modifying means modifies operation of the CPCD function and the identity of the CPCD function.

14. The CPCD of claim 1, further comprising a means for producing an alert when the modifying means modifies operation of the CPCD function.

15. The CPCD of claim 14, wherein the alert is generated locally on the CPCD itself and is communicated to the user of the CPCD.

16. The CPCD of claim 14, wherein the alert is communicated to a remote communication device.

17. A controlled personal communication device (CPCD), comprising:
means for determining location information;
means for storing one or more instructions indicative of one or more mandates of a legal jurisdiction; and
means for modifying operation of a CPCD function based at least in part upon the location information and the mandate instructions.

18. The CPCD of claim 17, wherein the CPCD function is at least one of the following: keypad, image display, microphone, speaker, camera, voice call out, voice call answer, text message creation, text message transmission, text message reception, email creation, email reception, image creation, image reception, Internet browsing, gaming, ring signal operation, communication signal transmission, and communication signal reception.

19. The CPCD of claim 17, further comprising a means for determining motion information and wherein the modifying means disables a communication function based upon the motion information, a predetermined threshold for the motion information, and the instructions indicative of one or more mandates of a legal jurisdiction.

20. The CPCD of claim 19, further comprising a means for re-enabling the communication function when a user attempts an emergency call so that the emergency call can be made by the user via the communication function.

21. The CPCD of claim 19, wherein the determining means further comprises a GPS receiver and a means for computing speed based upon measured GPS information and wherein the motion information is indicative of speed.

22. The CPCD of claim 19, wherein the determining means further comprises a GPS receiver and a means for computing acceleration based upon measured GPS information and wherein the motion information is indicative of acceleration.

23. The CPCD of claim 17, further comprising:
a GPS receiver for determining the location information;
wherein the modifying means modifies the CPCD function based, not only upon the instructions indicative of the mandates of the legal jurisdiction, but also the location information.

24. The CPCD of claim 23, further comprising:
means for accessing map information;
wherein the modifying means modifies the CPCD function based, not only upon the instructions indicative of the mandates of the legal jurisdiction and the location information, but also the map information.

25. The CPCD of claim 17, further comprising:
a clock for determining time information;
a GPS receiver for determining location information; and
wherein the modifying means modifies the CPCD function based, not only upon the instructions indicative of the mandates of the legal jurisdiction, but also the time information and the location information.

26. The CPCD of claim 17, further comprising:
means for determining that the CPCD function should be exempted from modification; and
means for overriding an attempt by the modifying means to disable the CPCD function in order to permit operation of the CPCD function.

27. The CPCD of claim 17, further comprising a user interface means for permitting input of one or more user preferences that define at least one of the following: when the modifying means modifies operation of the CPCD function and the identity of the CPCD function.

28. The CPCD of claim 17, further comprising a means for producing an alert when the modifying means modifies operation of the CPCD function.

29. The CPCD of claim 28, wherein the alert is generated locally on the CPCD itself and is communicated to the user of the CPCD.

30. The CPCD of claim 28, wherein the alert is communicated to a remote communication device.

31. A controlled personal communication device (CPCD), comprising:
means for determining motion information; and
means for producing an alert based at least in part upon the motion information.

32. The CPCD of claim 31, further comprising a means for modifying a CPCD function at least in part on the motion information and wherein the CPCD function is at least one of the following: keypad, image display, microphone, speaker, camera, voice call out, voice call answer, text message creation, text message transmission, text message reception, email creation, email reception, image creation, image reception, Internet browsing, gaming, ring signal operation, communication signal transmission, and communication signal reception.

33. The CPCD of claim 32, wherein the modifying means disables a CPCD function based upon the motion information and a predetermined threshold for the motion information.

34. The CPCD of claim 32, further comprising a means for re-enabling the CPCD function when a user attempts an emergency call.

35. The CPCD of claim 32, further comprising a means for receiving a CPCD function requirement associated with a legal jurisdiction and wherein the modifying means modifies the CPCD function based upon the legal jurisdiction requirement in addition to the motion information.

36. The CPCD of claim 32, wherein the determining means further comprises a GPS receiver and a means for computing speed based upon measured GPS information and wherein the motion information is indicative of speed.

37. The CPCD of claim 32, wherein the determining means further comprises a GPS receiver and a means for computing acceleration based upon measured GPS information and wherein the motion information is indicative of acceleration.

38. The CPCD of claim 32, further comprising:
a GPS receiver for determining location information;
wherein the modifying means modifies the CPCD function based, not only upon the motion information, but also the location information.

39. The CPCD of claim 38, further comprising:
means for accessing map information;
wherein the modifying means modifies the CPCD function based, not only upon the motion information and location information, but also the map information.

40. The CPCD of claim 32, further comprising:
a GPS receiver for determining location information;
means for determining a legal jurisdiction; and
wherein the modifying means modifies the CPCD function based, not only upon the motion information, but also the legal jurisdiction.

41. The CPCD of claim 32, further comprising:
a clock for determining time information;
a GPS receiver for determining location information; and
wherein the modifying means modifies the CPCD function based, not only upon the motion information, but also the time information.

42. The CPCD of claim 31, further comprising:
a clock for determining time information; and
wherein the producing means produces the alert based, not only upon the motion information, but also the time information.

43. The CPCD of claim 32, further comprising:
means for determining that the CPCD function should be exempted from modification; and
means for overriding an attempt by the modifying means to modify the CPCD function in order to permit normal operation of the CPCD function.

44. The CPCD of claim 31, further comprising a user interface means for permitting input of one or more user preferences that define at least one of the following: when the producing means produces an alert and the type of alert among a plurality of possible alerts.

45. The CPCD of claim 31, wherein the alert is generated locally on the CPCD itself and is communicated to the user of the CPCD.

46. The CPCD of claim 31, wherein the alert is communicated to a remote communication device.

47. A vehicle capable of transporting persons, comprising:
means for communicating a signal designed to prevent a CPCD from modifying a CPCD function based upon motion information.

48. The vehicle of claim 47, wherein the signal is directed to one or more locations inside the vehicle that can be occupied by a nondriver of the vehicle and wherein the signal is prevented from being directed to one or more driver locations within the vehicle.

49. The vehicle of claim 47, wherein the signal comprises one or more of the following: an electrical signal, a light signal, and an audio signal.

50. The vehicle of claim 47, wherein the signal is encoded by code that can be decoded by the CPCD.

51. A system for distributing control software for controlling a personal communication device (PCD) to enable a controlled PCD (CPCD), comprising:
means for communicatively coupling a PCD and a computer server over one or more networks;
means for engaging in a communication session involving the transfer of the control software from the server to the PCD, the control software designed to control operation of one or more CPCD functions of the CPCD based at least in part upon the motion information of the CPCD.

52. The system of claim 52, further comprising a means for charging a fee for communicating the control software to the PCD.

53. The system of claim 51, wherein the networks include at least one of the following: the Internet and the wireless telephone network.

54.-64. (canceled)

65. A controlled personal communication device (CPCD), comprising:
a processor designed to execute software instructions; and
a memory storing the software instructions, the software instructions designed to determine when the CPCD is interfaced with a remote microphone and speaker to enable hands-free operation of the CPCD and to modify operation of one or more CPCD functions based at least in part upon the interface information.

66.-67. (canceled)
